(19) United States
(12) Patent Application Publication
(10) Pub. No.: US 2007/0165248 A1
(43) Pub. Date: Jul. 19, 2007

(54) PRINTING APPARATUS AND PRINTING METHOD

(75) Inventors: Takeshi UTSUNOMIYA, Yokohama-shi (JP); Hiroyuki TAKAHASHI, Yokohama-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/623,040

(22) Filed: Jan. 12, 2007

(30) Foreign Application Priority Data
Jan. 13, 2006 (JP) 2006-006446(PAT.)
Jan. 10, 2007 (JP) 2007-002879(PAT.)

(51) Int. Cl. G06F 3/12

(52) U.S. Cl. 358/1.1

(57) ABSTRACT

This invention provides a printing apparatus and printing method capable of partially changing the print process conditions of a print job containing image data, and improving user friendliness. To accomplish this, a printing apparatus such as an MFP having a printing unit for printing based on a print job receives a print job containing image data of pages. When setting the print process conditions of the print job, the first print process conditions of the first page group of pages and the second print process conditions of the second page group of pages are set to different conditions. Image data of the first page group are printed under the first print process conditions, whereas image data of the second page group are printed under the second print process conditions.

### BACKGROUND OF THE INVENTION

1. Field of the Invention

The present invention relates to a printing apparatus and printing method.

2. Description of the Related Art

A commercial printing workflow accumulates, in a printing apparatus, a print job transferred to it and repeats test printing. The function of accumulating a print job in the printing apparatus is called a “hold function”. There is a demand for the ability to change print settings for each page when a printing apparatus having the hold function prints from an accumulated print job.

To meet this demand, there is known a technique of sequentially queuing accepted print jobs and changing the print process conditions of a queued print job in accordance with a change instruction (Japanese Patent No. 3,344,150). There is also known a technique of setting print process conditions for each page when generating a print job based on document data (Japanese Patent Laid-Open No. 07-134707).

However, the conventional techniques cannot partially change the print process conditions of one print job in the printing apparatus after transferring the print job to the printing apparatus. For example, when a plurality of paper types are designated in one print job, change of the paper type means change of the sheet feed cassette used for a print process. The difference in paper conveyance path may change the print position of an image on a sheet.

In this case, the print position of an image on a sheet must be adjusted for each paper type. However, the above-mentioned conventional techniques validate change of print process conditions throughout an entire print job (all pages), and uniformly adjust the print position of an image on sheets of all types. These techniques cannot adjust the print position of an image on a sheet of only a specific page. The conventional techniques can partially change print process conditions, but the print process conditions are set when generating a print job and cannot be changed after transmitting a print job to the printing apparatus. In this case, a user must transmit a print job again to the printing apparatus from a client PC which generates the print job.

### SUMMARY OF THE INVENTION

The present invention enables to provide a printing apparatus and printing method capable of partially changing the print process conditions of a print job containing image data of pages, and improving user friendliness.

According to the present invention, the foregoing problem is solved by providing a printing system including an information processing apparatus and a printing apparatus,
the information processing apparatus comprising:
   a setting unit adapted to set, for each page range, a print process condition used to print image data of a plurality of pages;
   a generation unit adapted to generate a print job including the print process condition set by the setting unit and the image data; and
   a transmission unit adapted to transmit the print job generated by the generation unit to the printing apparatus, and
the printing apparatus comprising:
   a reception unit adapted to receive the print job transmitted by the transmission unit;
   a change unit adapted to change, for each page range, the print process condition included in the print job received by the reception unit; and
   a printing unit adapted to execute the print job based on the print process condition changed by the change unit.

According to the present invention, the foregoing problem is solved by providing a printing apparatus communicating with an information processing apparatus having a setting unit adapted to set, for each page range, a print process condition used to print image data of a plurality of pages, a generation unit adapted to generate a print job including the print process condition set by the setting unit and the image data, and a transmission unit adapted to transmit the print job generated by the generation unit to the printing apparatus, the printing apparatus comprising:
a reception unit adapted to receive the print job transmitted by the transmission unit;
a change unit adapted to change, for each page range, the print process condition contained in the print job received by the reception unit; and
a printing unit adapted to execute a print process based on the print process condition changed by the change unit.

According to the present invention, the foregoing problem is solved by providing a method for printing, comprising the steps of:
causing an information processing apparatus to set, for each page range, a print process condition used to print image data of a plurality of pages;
causing the information processing apparatus to generate a print job by adding the print process condition set to the image data of the plurality of pages;
transmitting the generated print job from the information processing apparatus to a printing apparatus;
causing the printing apparatus to receive the transmitted print job;
causing the printing apparatus to change, for each page range, the print process condition contained in the received print job; and
causing the printing apparatus to execute a print process on the basis of the changed print process condition.

Further features of the present invention will be apparent from the following description of exemplary embodiments with reference to the attached drawings.

### BRIEF DESCRIPTION OF THE DRAWINGS

FIG. 1 is a block diagram showing an example of the basic configuration of an overall printing system according to the first embodiment of the present invention;

FIG. 2 is a sectional view showing the detailed arrangement of an MFP 100 shown in FIG. 1;

FIG. 3 is a block diagram showing a detailed arrangement around an MFP control unit 108 which controls the MFP 100 shown in FIG. 2;

FIG. 4 is a block diagram showing the firmware structure of the MFP control unit 108 according to the first embodiment;

FIG. 5 is a view showing an example of the layout of a printer driver setup window;.

FIG. 6 is a view showing an example of the layout of a property setup window associated with the page setting process of a printer driver;

FIG. 7 is a view showing an example of the layout of a property setup window for defining a setting application range for each page and making settings for each application range;

FIG. 8 is a view showing the structure of job data generated by the printer driver;

FIG. 9 is a schematic view of a touch panel portion (hold list) showing a window displayed when a user selects a “hold list” from windows displayed on the display unit of an image forming apparatus in the first embodiment;

FIG. 10 is a schematic view of a touch panel portion (application range list) which displays a list of print process condition application ranges to a job;

FIG. 11 is a schematic view of a touch panel portion (application range list) which displays a list of print process condition application ranges to a job;

FIG. 12 is a schematic view of a touch panel portion (edit window) serving as a window for changing each print process condition;

FIG. 13 is a table showing a hold job management table for managing a job stored in a hold queue in a printing apparatus;

FIG. 14 is a flowchart for explaining the sequence of a main process by the printing apparatus according to the first embodiment;

FIG. 15 is a flowchart for explaining details of a hold storage process in step S111;

FIG. 16 is a flowchart for explaining details of a hold cancellation process to print data stored in a hold queue 129 in step S111;

FIG. 17 is a flowchart for explaining a hold list display process by controlling the window shown in the schematic view of the touch panel portion (hold list) in FIG. 9;

FIG. 18 is a flowchart for explaining an application range list display process by controlling the window shown in the schematic view of the touch panel portion (application range list) in FIG. 10 or 11;

FIG. 19 is a perspective view showing the structure of an auto document feeder (ADF) employed in the second embodiment;

FIG. 20 is a sectional view showing the structure of the auto document feeder (ADF) employed in the second embodiment;

FIG. 21 is a schematic view of an example of the window of a touch panel portion (application range list) displayed in a printing apparatus according to the second embodiment;

FIG. 22 is a flowchart for explaining an ADF successive reading process to successively read divided document bundles from the ADF, and store their data as one print job in the hold queue;

FIG. 23 is a view showing a window displayed when selecting a “hold list” by a user operation;

FIG. 24 is a view showing a window displayed on an operation unit 120;

FIG. 25 is a view showing a window displayed on the operation unit 120;

FIG. 26 is a view showing a window displayed on the operation unit 120;

FIG. 27 is a view showing a window displayed on the operation unit 120;

FIG. 28 is a view showing a window displayed on the operation unit 120;

FIG. 29 is a view showing a window displayed on the operation unit 120;

FIG. 30 is a view showing a window displayed on the operation unit 120;

FIG. 31 is a view showing a window displayed on the operation unit 120;

FIG. 32 is a view showing a window displayed on the operation unit 120;

FIG. 33 is a view showing a window displayed on the operation unit 120;

FIG. 34 is a view showing a window displayed on the operation unit 120;

FIG. 35 is a view showing a window displayed on the operation unit 120;

FIG. 36 is a view showing a window displayed on the operation unit 120;

FIG. 37 is a view showing a window displayed on the operation unit 120;

FIG. 38 is a view showing a window displayed on the operation unit 120;

FIG. 39 is a view showing a window displayed on the operation unit 120;

FIG. 40 is a view showing a window displayed on the operation unit 120;

FIG. 41 is a view showing a window displayed on the operation unit 120;

FIG. 42 is a view showing a window displayed on the operation unit 120;

FIG. 43 is a view showing a window displayed on the operation unit 120;

FIG. 44 is a view showing a window displayed on the operation unit 120;

FIG. 45 is a view showing a window displayed on the operation unit 120;

FIG. 46 is a view showing a window displayed on the operation unit 120;

FIG. 47 is a view showing a window displayed on the operation unit 120;

FIG. 48 is a view showing a window displayed on the operation unit 120;

FIG. 49 is a view showing a window displayed on the operation unit 120;

FIG. 50 is a view showing a window displayed on the operation unit 120;

FIG. 51 is a view showing print process conditions set in a print job;

FIG. 52 is a view showing print process conditions set in the print job;

FIG. 53 is a flowchart for explaining an operation executed by the MFP control unit 108; and

FIG. 54 is a table showing an example of print process condition information (job ticket information) held by a document management unit. 114.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

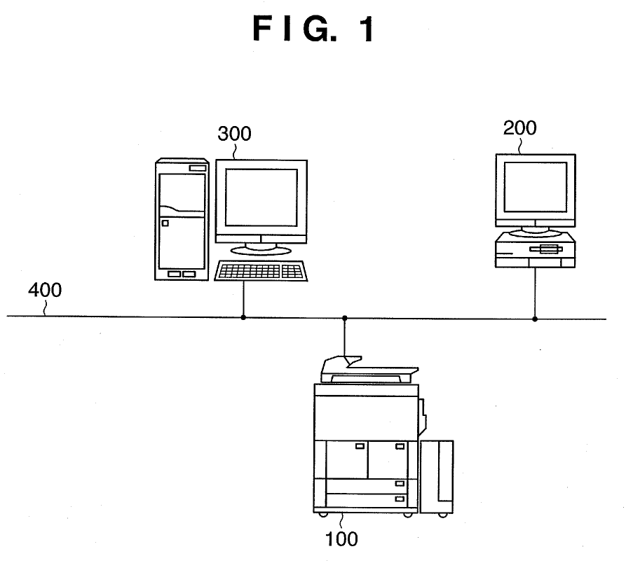

FIG. 1 is a block diagram showing an example of the basic configuration of an overall printing system according to the first embodiment of the present invention. As shown in FIG. 1, according to the first embodiment, the printing system includes an MFP (MultiFunction Peripheral) 100, client PC 200, and print server 300, which connect to a network 400.

The MFP 100 has various functions such as scanning, printing, and copying functions. The client PC 200 plays the role of editing an input application file, issuing a print instruction, or inputting a print ready file, and the role of assisting monitoring and control of devices and jobs managed in the print server. A print job generated by the client PC 200 is transferred to the MFP 100 directly or via the print server 300.

The print server 300 has two roles. One role is to transmit/receive information between the MFP 100 and the client PC 200. The print server 300 receives image information, setting information, and the like of a print job input from the client PC 200, and after the end of the print job, informs the client PC 200 of information such as the status. The other role is to manage and control the MFP 100. The print server 300 unitarily manages a print job input from the client PC 200 and a print job generated in the MFP 100. The print server 300 can monitor the statuses of all print jobs held in the MFP 100. The print server 300 can control suspension, setting changes, and print restart of a print job, or copying, movement, and deletion of a print job.

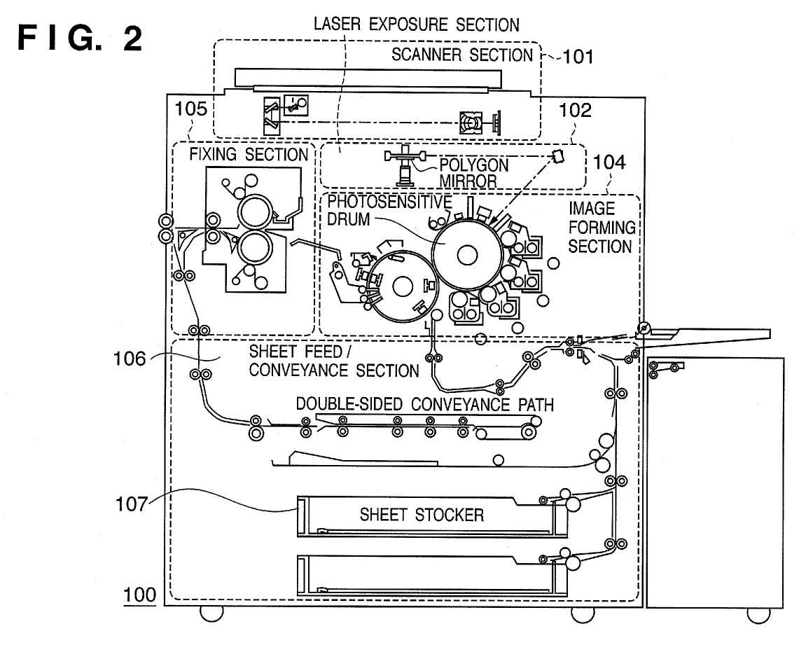

FIG. 2 is a sectional view showing the detailed arrangement of the MFP 100 shown in FIG. 1. The MFP 100 in the first embodiment can print in color. The MFP 100 comprises a scanner section 101, a laser exposure section 102, photosensitive drums 303, an image forming section 104, a fixing section 105, a sheet feed/conveyance section 106, and a printer control section (not shown) which controls these sections.

The scanner section 101 illuminates a document set on a document table, optically scans the document image, and converts the image into an electrical signal to create image data. The laser exposure section 102 emits a light ray such as a laser beam modulated in accordance with the image data to a rotary polygon mirror which rotates at an equiangular velocity. Then, the laser exposure section 102 irradiates the photosensitive drum 103 with the light ray as reflected scanning light.

The image forming section 104 forms an image by a series of electrophotographic processes. More specifically, the image forming section 104 drives and rotates the photosensitive drum 103, charges it using a charger, and develops a latent image formed on the photosensitive drum 103 with toner by the laser exposure section 102. Then, the image forming section 104 transfers the toner image onto a sheet, and recovers a small amount of toner which is not transferred and remains on the photosensitive drum 103. Developing units (developing stations) respectively containing magenta (M), cyan (C), yellow (Y), and black (K) toners repetitively execute the above electrophotographic processes in turn while a sheet is wound around at a predetermined position on the transfer belt and rotates four times. After the four turns, the sheet bearing the full-color toner image of the four colors is separated from the transfer drum and conveyed to the fixing section 105.

The fixing section 105 comprises a combination of rollers and belts. The fixing section 105 incorporates a heat source such as a halogen heater, and fuses and fixes by heat and pressure the toner on the sheet on which the toner image is transferred by the image forming section.

The sheet feed/conveyance section 106 has at least one sheet stocker typified by a sheet cassette or paper deck. The sheet feed/conveyance section 106 separates one of the sheets stored in a sheet stocker 107 from the rest in accordance with an instruction from the printer control section (not shown), and conveys the sheet to the image forming section 104 and fixing section 105. The sheet is wound around the transfer drum of the image forming section 104, rotates four times, and then is conveyed to the fixing section 105. During the four turns, Y, M, C, and K toner images are transferred onto the sheet. To print on both surfaces of the sheet, the sheet having passed through the fixing section 105 is controlled to pass through a conveyance path extending to the image forming section 104 again.

The printer control section communicates with an MFP control unit for controlling the whole MFP 100, and executes control in accordance with an instruction from the MFP control unit. Also, while the printer control section manages the statuses of the scanner section 101, laser exposure section 102, image forming section 104, fixing section 105, and sheet feed/conveyance section 106, it instructs them to keep the balance and operate smoothly.

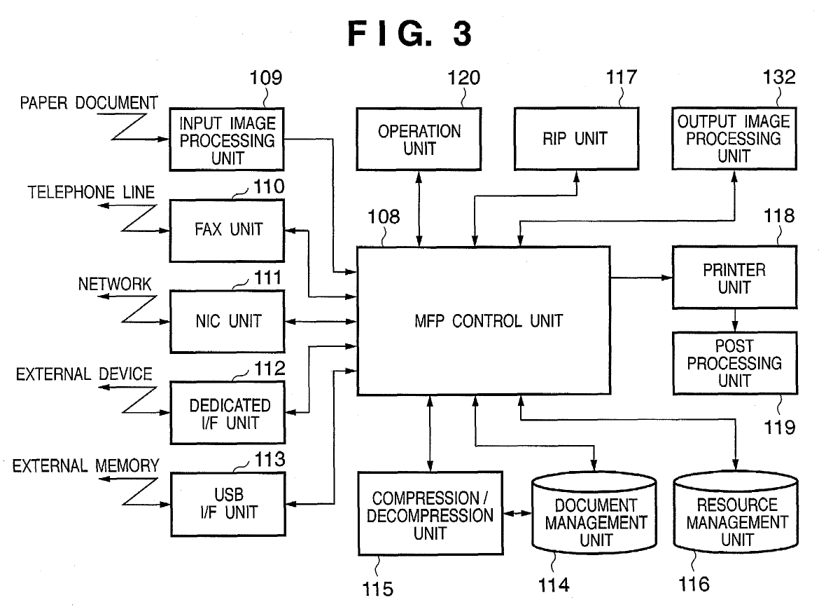

FIG. 3 is a block diagram showing a detailed arrangement around an MFP control unit 108 which controls the MFP 100 shown in FIG. 2. The MFP 100 incorporates a memory such as a hard disk capable of storing a plurality of job data. The MFP 100 has a copying function of printing job data output from a scanner by the printer unit via the memory. The MFP 100 also has a plurality of functions such as a printing function of printing a print job input from the client PC 200 by the printer unit via the memory.

The MFPs 100 are classified into full-color MFPs and monochrome MFPs. In many cases, the full-color MFP includes the arrangement of the monochrome MFP at the basic part except without a color process, internal data, and the like. The first embodiment will explain mainly the full-color MF, and a description of the monochrome MFP will be added, as needed.

The printing system may comprise a multifunction type printing apparatus having a plurality of functions, and an SFP (Single Function Printer) which is a single function type printing apparatus having only a printing function. Alternatively, the printing system may comprise a printing apparatus of either type. The printing system may also comprise a plurality of printing apparatuses of either type. In any case, the printing system is configured to implement control according to the first embodiment.

As shown in FIG. 3, the MF control unit 108 connects to an input image processing unit 109 which reads an image of a paper document or the like and processes the read image data, and a FAX unit 110 which is typified by a facsimile machine or the like and transmits/receives an image using a telephone line. The MFP control unit 108 also connects to a NIC (Network Interface Card) unit 111 which exchanges image data and apparatus information using a network, and a dedicated interface unit 112 which exchanges information such as image data with an external device. The MFP control unit 108 further connects to a USE (Universal Serial Bus) interface unit 113 which exchanges image data and the like with a USB device typified by a USB memory (kind of removable medium).

The MFP control unit 108 controls to temporarily save image data in accordance with the application purpose of the MFP 100 or determine the path. A document management unit 114 comprises a memory such as a hard disk capable of storing a plurality of image data. The control unit (e.g., the CPU of the MFP control unit 108) of the MFP 100 functions as a main unit to control to store a plurality of types of image data in the memory. These image data include image data from the input image processing unit 109, and image data of a facsimile job input via the FAX unit 110. The image data further include a print job input from the client PC 200 via the NIC unit 111, and various print jobs input from the dedicated I/F unit 112 and USB I/F unit 113. The control unit properly reads out a print job stored in the memory such as a hard disk, and transfers the print job to a printer unit 118, which prints. The control unit transfers; to the client PC, another printing apparatus, or the like, image data read out from the memory in accordance with an instruction from an operator.

When storing a print job in the document management unit 114, image data contained in a print job is compressed and stored, as needed. When reading out compressed/stored image data, the image data is decompressed into original image data. The MFP control unit 108 performs these processes via a compression/decompression unit 115. It is generally known that data compressed by JPEG, JBIG, ZIP, or the like is used when transferring image data through a network. After inputting image data to the MFP 100, the compression/decompression unit 115 decompresses it.

A resource management unit 116 stores various common parameter tables and the like (e.g., the font, color profile, and gamma table), and can call the tables, as needed. In addition, the resource management unit 116 can store a new parameter table, or correct and update a parameter table.

When the MFP control unit 108 receives PDL data as a print job, a RIP unit 117 performs a RIP (Raster Image Processor) process, or if necessary, an output image processing unit 132 executes an image process for printing. If necessary, the document management unit 114 can store again intermediate data of image data generated at this time, and print ready data (bitmap data for printing or its compressed data).

The printer unit 118 for printing receives image data. The printer unit 118 supplies a printed sheet (paper) to a post processing unit 119, which performs a sheet sorting process and sheet finishing process.

The MFP control unit 108 plays the role of smoothly facilitating a print job, and switches the path as follows in accordance with the usage of the MFP 100. It is generally known to store image data as intermediate data, as needed. However, a description of accesses except those which start and end in the document management unit 114 will be omitted. A flow will be roughly described by omitting processes by the compression/decompression unit 115 and post processing unit 119 which are used as needed, those by the MFP control unit 108 serving as the core of the whole system, and the like.

A) Copying function: the input image processing unit→the output image processing unit→the printer unit

B) FAX transmission function: the input image processing unit→the FAX unit

C) FAX reception function: the FAX unit→the output image processing unit→the printer unit

D) Network scan: the input image processing unit→the NIC unit

E) Network printing: the NIC unit→the RIP unit→the output image processing unit→the printer unit

F) Scan to external device: the input image processing unit→the dedicated I/F unit

G) Printing from external device: the dedicated I/F unit→the output image processing unit→the printer unit

H) Scan to external memory: the input image processing unit→the USB I/F unit

I) Printing from external memory: the USB I/F unit→the RIP unit→the output image processing unit→the printer unit

J) Box scan function: the input image processing unit→the output image processing unit→the document management unit

K) Box printing function: the document management unit→the printer unit

L) Box reception function: the NIC unit→the RIP unit→the output image processing unit→the document management unit

M) Box transmission function: the document management unit→the NIC unit

N) Preview function: the document management unit→an operation unit

In addition to the above functions, combinations with various functions such as an E-mail service and Web server function are conceivable.

Box scan, box printing, box reception, or box transmission is a processing function of the MFP 100 accompanying write and read of data using the document management unit 114. These processing functions are to divide the memory in the document management unit for respective jobs and respective users, temporarily save data, and input/output data in combination with a user ID and password.

A user uses an operation unit 120 to select various flows and functions described above and designate an operation. With the high-resolution display device of the operation unit 120, the operation unit 120 enables previewing of image data in the document management unit 114, and if the image data is checked “OK”, also enables printing of the image data.

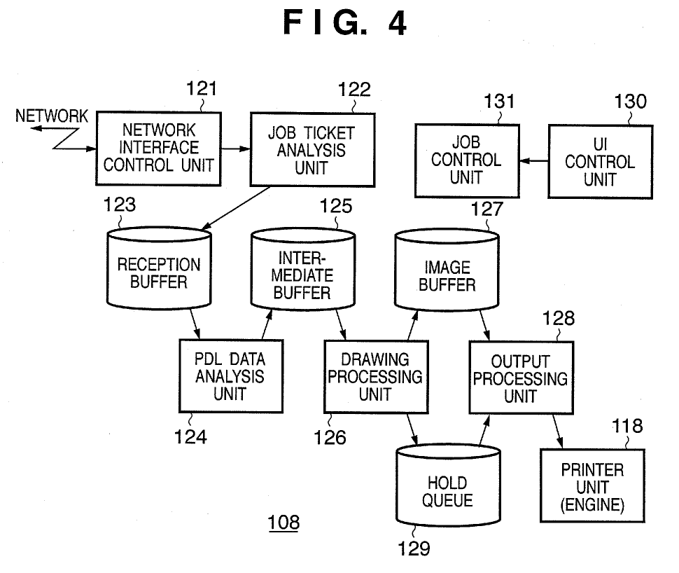

FIG. 4 is a block diagram showing the firmware structure of the MFP control unit 108 according to the first embodiment. In FIG. 4, a network interface control unit 121 connects to a network via an interface cable. The network interface control unit 121 controls communication between the client PC 200 and the print server 300. The network interface control unit 121 receives a print job from the client PC 200 or print server 300, and transfers the received print job to a job ticket analysis unit 122. The job ticket analysis unit 122 analyzes a job ticket contained in the print job, and transfers the print process conditions of the print job to a job management unit. The job ticket analysis unit 122 stores the received print job in a reception buffer 123.

When the reception buffer 123 stores the print job (PDL data), a PDL data analysis unit 124 starts a process. The PDL data analysis unit 124 reads the PDL data from the reception buffer 123, analyzes it, generates an object (intermediate code) corresponding to each command, and stores the object in an intermediate buffer 125. In the first embodiment, a command supported by the printer is PDL (Page Description Language) data, but all data capable of printing for each page are processed similarly to PDL data. Intermediate data is managed for each page.

When the intermediate buffer 125 stores data, a drawing processing unit 126 operates. The drawing processing unit 126 reads out intermediate data of each page from the intermediate buffer 125, generates one-page print image data, and stores it in an image buffer 127. After generating the one-page print image data, an output control unit 128 operates. For a hold-designated job, a hold queue 129 stores image data. The output control unit 128 does not start up immediately, but when the UI control unit 130 issues a hold cancellation (print) instruction, starts up and prints the job.

“Hold” means a function of not executing a print job immediately, but temporarily storing it in the document management unit 114 and starting printing in accordance with an instruction from a user. This function is used to perform test printing, and if the print result is proper, perform actual printing (a plurality of copies). This function enables actual printing without transmitting a print job from the client PC 200 again.

The output control unit 128 actually prints by reading out image data from the image buffer 127, converting it into a video signal, and transferring, to the printer unit 118, the video signal which is to be transferred to the engine.

A UI control unit 130 controls a UI (User Interface), and comprises a display unit and operation unit. The display unit adopts a liquid crystal display or the like. The operation unit has keys. A touch panel type display unit sometimes functions as the operation unit. The UI control unit 130 controls the display of a character string corresponding to a user operation, window switching, and transmission of setting values to another module.

A job control unit 131 manages a job in the apparatus, and controls generation and deletion of a job, the job status, the job processing order, and the like.

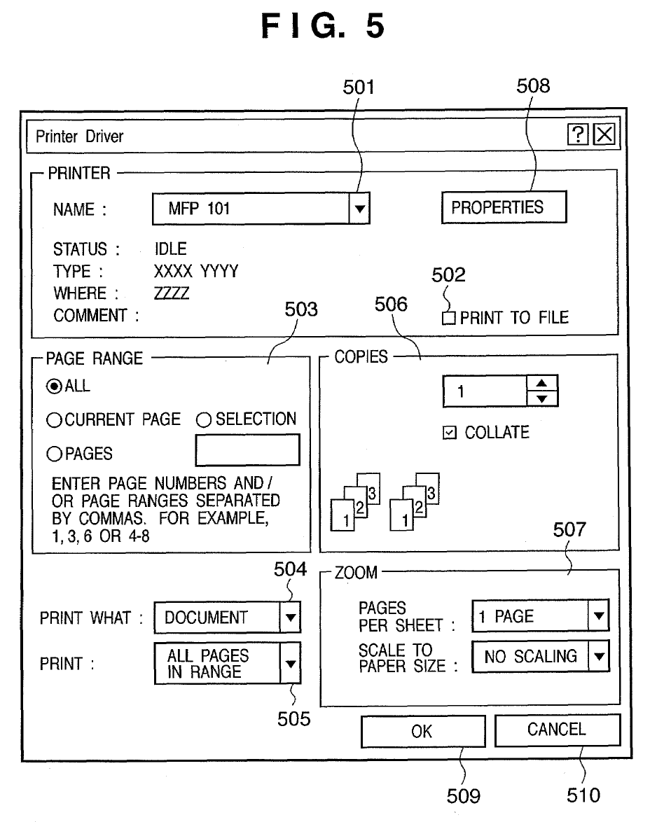

FIG. 5 is a view showing an example of the layout of a printer driver setup window. The printer driver is used as a means for outputting a proof from a printing application to a print device such as an MFP, and outputting a final material. The printer driver setup window as shown in FIG. 5 is generally displayed when an operator selects the print menu of the printing application in transmitting a job to the MFP 100.

The operator selects a print device for use from a “printer name” pull-down list box 501 in the setup window. Then, “status” below the “printer name” pull-down list box 501 displays the status of a print device, “type” displays the type of the printer driver, “where” displays installation location information for the print device, and “comment” displays comment information from a print device administrator. To output a print job to a file without transmitting it to a printing apparatus such as the MFP 100, the operator selects a “print to file” check box 502.

In “page range” 503, the operator designates pages to be printed by selecting one of radio buttons “all”, “current page”, “selection”, and “pages”. When selecting “pages”, the operator inputs target page numbers in the edit box.

The operator selects the print process conditions of a target document from a “print what” pull-down list box 504. The operator designates, from a “print” pull-down list box 505, whether to print all pages or only odd- or even-numbered pages.

In “copies” 506, the operator inputs the number of copies to be printed in the “number of copies” spin box. To print a plurality of copies not page by page but copy by copy, the operator selects a “collate” check box.

In “zoom” 507, the operator designates N-up printing (printing a layout of a plurality of pages on one print plane) from a “pages per sheet” pull-down list box. The operator selects a paper size from a “scale to paper size” pull-down list box.

By pressing a “properties” button 508, the operator can set more detailed print process conditions.

At the end of setting in the printer driver setup window, the operator can press an “OK” button 509 to transmit a print job to the printing apparatus such as the MFP 100 or output it to a file. To stop a print process or file output, the operator presses a “cancel” button 510.

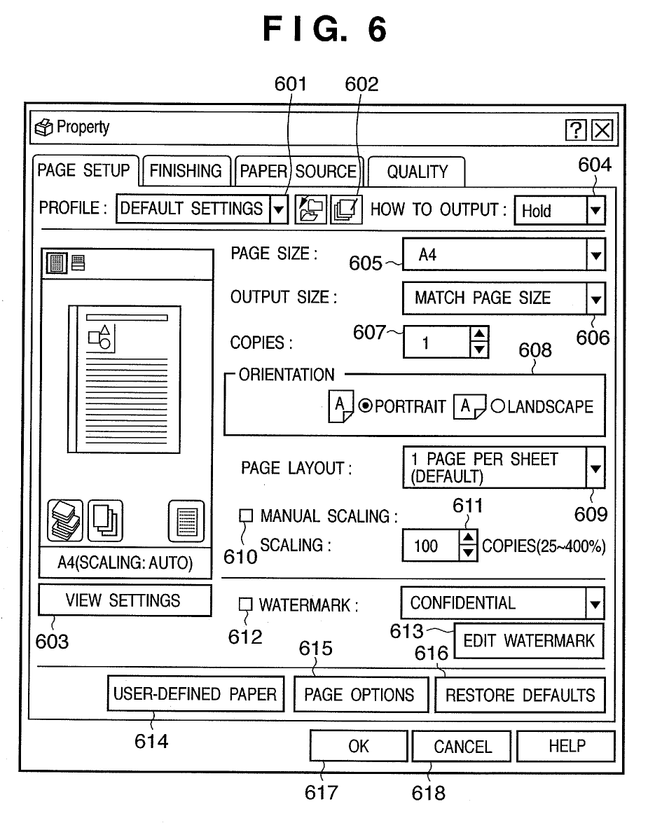

FIG. 6 is a view showing an example of the layout of a property setup window associated with the page setting process of the printer driver.

The printer driver property setup window shown in FIG. 6 is the default window when the operator presses the “properties” button 509 in the printer driver setup window. Alternatively, the printer driver property setup window is displayed by selecting the “page setup” tab in the printer driver property setup window.

In a “profile” pull-down list box 601, the operator selects optimal page settings from predetermined page setting modes. The operator can add or edit the profile option with two buttons 602 adjacent to the “profile” pull-down list box 601.

By pressing a “view settings” button 603, the operator can display a list of contents set in the property setup window. A page image displayed in the property setup window reflects contents set in the property setup window.

In a “how to output” pull-down list box 604, the operator designates the output method of normally printing by the printing apparatus such as the MFP 100 or saving a print job in the hold queue (hard disk) of the printing apparatus. When the operator selects the option to hold the print job in the queue the hold queue of the print device temporarily stores the job without printing on a sheet. In this case, the print process on a sheet starts in accordance with a print instruction (cancellation instruction) from the user.

The operator selects a target page size and the paper size used in the print process by the printing apparatus from a “page size” pull-down list box 605 and “output size” pull-down list box 606. The operator inputs the number of copies to be printed to a “copies” spin box 607, and selects the sheet print layout of the printing apparatus such as “portrait” or “landscape” with an “orientation” radio button 608.

The operator designates N-up printing (printing of a layout of a plurality of pages (N pages) on one print plane) from a “page layout” pull-down list box 609. When selecting the “manual scaling” check box 610, the operator inputs the scaling ratio as a percent into the “scaling” spin box 611.

When selecting the “watermark” check box 612, the operator selects a predetermined watermark type from a pull-down list box. By pressing the “edit watermark” button 613, the operator can add or edit a watermark type.

The operator can define user-defined paper by pressing the “user-defined paper” button 614, or set detailed page options by pressing a “page options” button 615. By pressing a “restore defaults” button 616, the operator can return these settings to the defaults.

At the end of setting in the printer driver property setup window, the operator can press the “OK” button 617 to reflect these print process conditions in actual printing. To stop settings in the property setup window, the operator presses the “cancel” button 618. The “help” button 619 displays a help window for the property setup window.

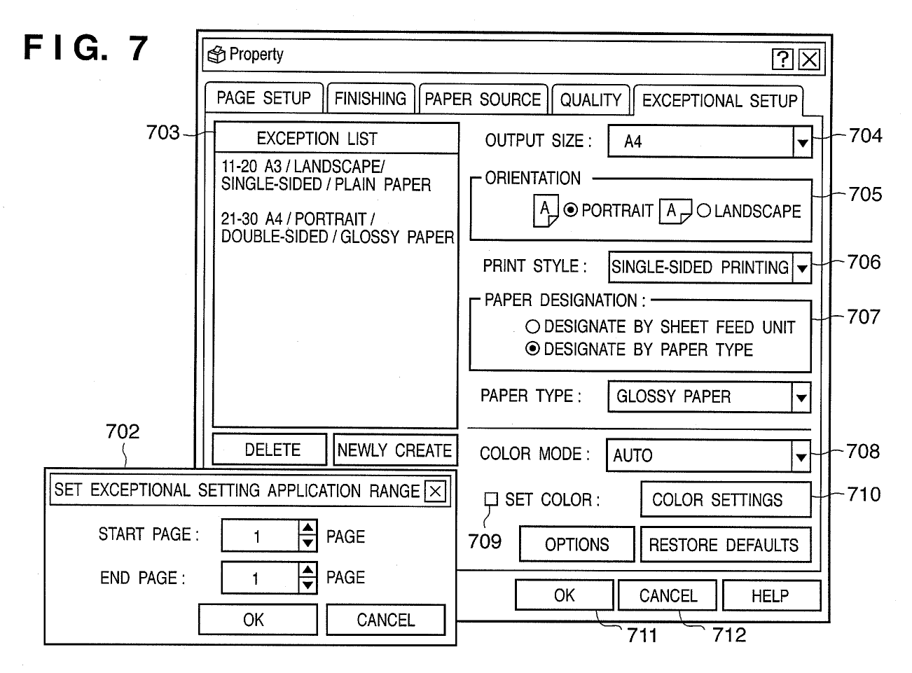

FIG. 7 is a view showing an example of the layout of a property setup window for defining a setting application range for each page and making settings for each application range. The properties of an entire job are set in another property setup window. The window in FIG. 7 is used to set property setting values partially (ranging from a given start page to a given end page). Pages (page range) not designated in this window comply with common settings (settings from another property window).

In FIG. 7, when the operator presses a new creation button 701, a “set exceptional setting application range” popup window 702 (lower left) appears. The operator designates start and end pages in the “set exceptional setting application range” window, and presses the OK button. Then, the popup window disappears, and an “exception list” 703 displays a set range. The range registered in the exception list 703 is the setting unit of properties (print process conditions).

The operator selects a range to be set from the “exception list” 703, and sets properties.

The operator selects an output paper size from the “output size” pull-down list box 704. In the “orientation” check box 705, the operator designates the portrait or landscape as the orientation. The operator selects a print style such as “single-sided printing”, “double-sided printing”, or “bookbinding printing” from the “print style” pull-down list box 706.

In the “paper designation” check box 707, the operator selects whether the paper is designated by sheet feed stage or by paper type. To designate paper by sheet feed stage, the “sheet feed stage” pull-down list box is displayed to allow the operator to select a sheet feed stage (e.g., cassette 1, cassette 2, cassette 3, or auto). To designate paper by paper type, a “paper type” pull-down list box is displayed to allow the operator to select a paper type (e.g., plain paper, thick paper, glossy paper, or OHP).

The operator selects color, monochrome, or auto from the “color mode” pull-down list box 708. In the “set color” check box 709, the operator selects whether to set a color. If the check box is checked, the color complies with a setting made in a color setup window (not shown). The operator presses a “color settings” button 710 to shift to the color setup window.

The operator presses the “OK” button 711 to finalize the settings, and the window returns to the printer driver setup window shown in FIG. 6. By pressing the “OK” button 617 in the printer driver setup window shown in FIG. 6, job data made up of PDL data and a job ticket corresponding to property settings is generated and transmitted to the print server 300 or MFP 100.

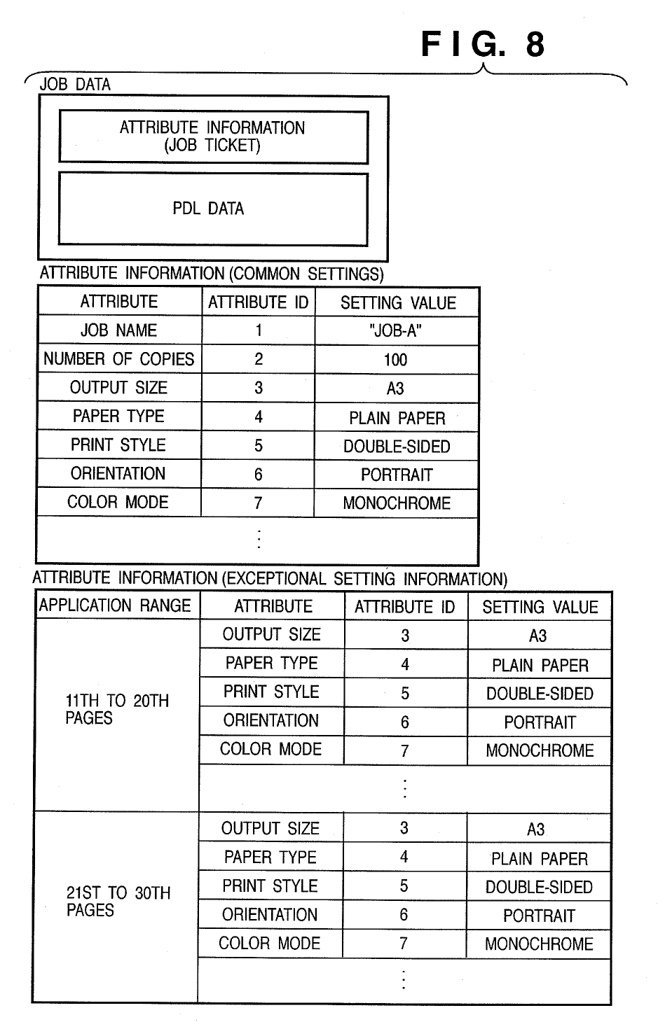

FIG. 8 is a view showing the structure of a print job generated by the printer driver. The print job contains print process condition information (job ticket) and PDL data.

The print process condition information contains two types of settings: common settings and exceptional settings. The print process condition information (common settings) stores print process conditions such as “job name”, “number of copies”, “output size”, “paper type”, “print style”, “orientation”, and “color mode”.

The print process condition information (exceptional settings) stores information on “start page” and “end page” as the “application range”. The print process condition information (exceptional settings) further stores print process conditions such as “job name”, “number of copies”, “output size”, “paper type”, “print style”, “orientation”, and “color mode”. The example shown in FIG. 8 describes a job of 30 pages. Of the 30 pages, the 11th to 20th pages and the 21st to 30th pages are defined as application ranges. The remaining first to 10th pages not defined as an exception comply with the common settings.

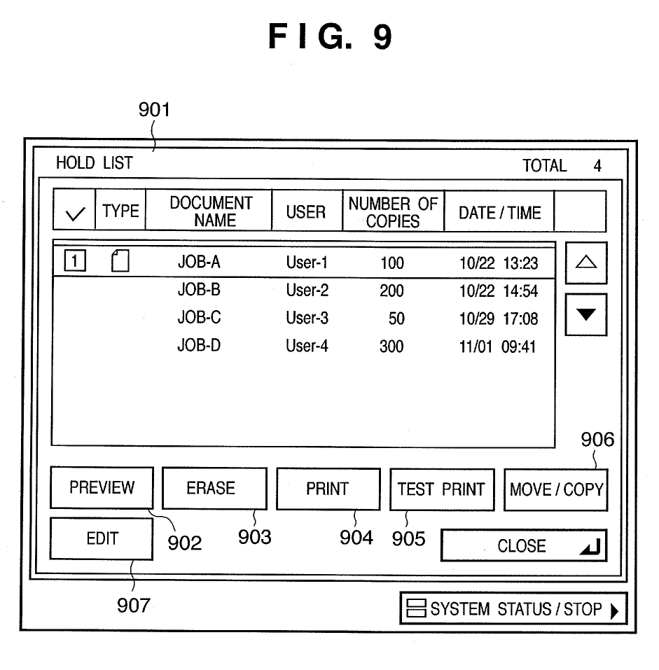

FIG. 9 is a schematic view of a touch panel portion (hold list), and shows a window displayed when a user selects the “hold list” out of windows displayed on the display unit of the printing apparatus in the first embodiment. The hold queue of the MFP 100 stores a print job hold-designated from the printer driver. A “hold list” 901 is a list of jobs stored in the hold queue. The “hold list” 901 displays the print process conditions of each job (e.g., a job name, a user name, the number of pages, and a date and time when the job was stored). The contents of the displayed print process conditions comply with job ticket information generated by the printer driver. A user selects one or a plurality of jobs from the hold job list, and presses each operation button at the lower portion in the window, thereby performing the following operation.

The user presses a “preview” button 902 to display a preview image of a selected job. It is also possible to select any page from the preview window and preview it. The user can press the “erase” button 903 to erase a job from the hold queue. The user can press the “print” button 904 to print the job. The first embodiment erases the job from the hold queue upon completion of printing.

The user can press the “test print” button 905 to print only one copy of a job. The first embodiment does not erase the job from the hold queue upon completion of test printing. Also, test printing does not decrement the number of copies set for the job.

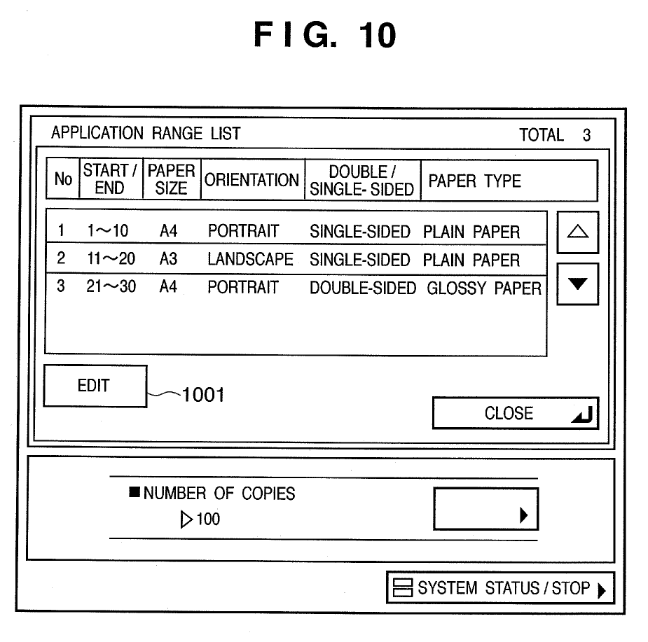

The user can press the “move/copy” button 906 to move the job to another queue (not shown) or copy the job. The user can press the “edit” button 907 to change each print process condition. In the first embodiment, the window in FIG. 9 changes to a window shown in the schematic view of a touch panel portion (application range list) in FIG. 10 when the “edit” button 907 is pressed.

FIG. 10 is a schematic view of the touch panel portion (application range list) which displays a list of print process condition application ranges to a print job. The printer driver generates a list in accordance with print process condition information (job ticket information) of a generated print job. This window displays the setting values of the print process conditions for each range. Displayed print process conditions are, e.g., “start page/end page”, “paper size”, “orientation”, “single/double-sided”, and “paper type”.

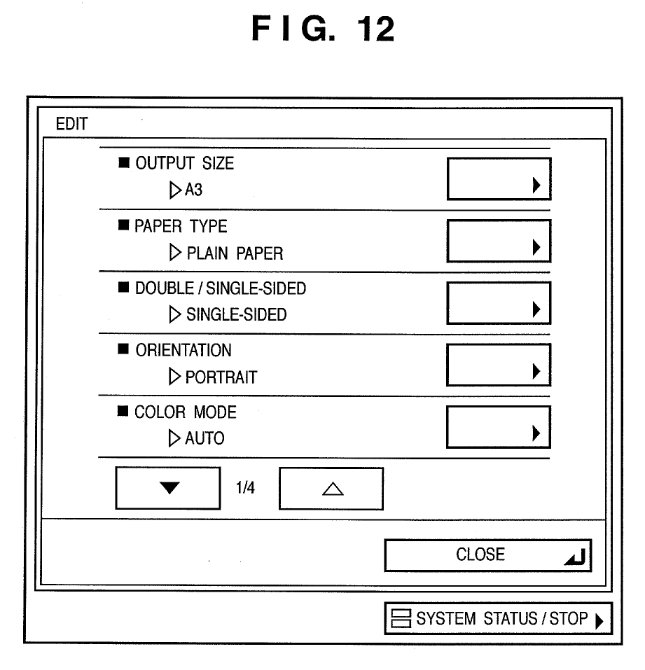

The user selects one or a plurality of application ranges from the list, and presses the “edit” button 1001 at the lower portion of the window, thereby changing print process condition values for each application range. In the first embodiment, when the user selects an “application range” and presses the “edit” button, the window in FIG. 10 changes to a window shown in the schematic view of the touch panel portion (edit window) in FIG. 12.

The application range of the number of copies or the like (print process condition whose range cannot be divided and set), which is applicable only to an entire job, is displayed and changed in this window.

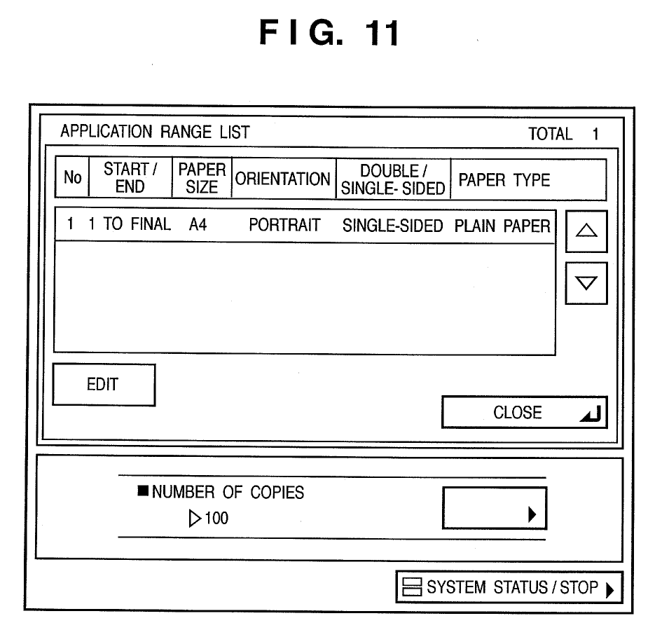

For a print job having no exceptional setting from the printer driver, a window as shown in the schematic view of a touch panel portion (application range list) in FIG. 11 is displayed. The window in FIG. 11 displays only one application range, and displays the start page “1” and the end page “final” or the like. Print process conditions such as the paper size, orientation, double/single-sided printing, and paper type are displayed in accordance with the common settings of the job ticket of job data.

FIG. 12 is a schematic view of the touch panel portion (edit window) serving as a window for changing each print process condition. The window in FIG. 12 enables changing print process conditions (e.g., paper size, paper type, double/single-sided printing, orientation, and color mode), image shift print process conditions (not shown), and the like. The user changes the print process conditions of a print job in the hold queue by changing settings in the setup window (not shown) of each print process condition and pressing the OK button.

When the user presses the button 1201 for changing the output size, an output size setup window appears. The user selects “A4” as the output size in this window to change the output size from “A3” to “A4”. When the user presses the button 1202 for changing the paper type, a paper type setup window appears. The user selects the paper type “thick paper” in this window to change the paper type from “plain paper” to “thick paper”. When the user presses the button 1203 for changing double/single-sided printing, a double/single-sided setup window appears. The user selects “double-sided” in this window to change the double/single-sided setting from “single-sided” to “double-sided”. When the user presses the button 1204 for changing the orientation, an orientation setup window appears. The user selects the orientation “landscape” in this window to change the orientation from “portrait” to “landscape”. When the user presses the button 1205 for changing the color mode, a color mode setup window appears. The user selects the color mode “color” in this window to change the color mode from “auto” to “color”.

The changes in the print process conditions in FIG. 12 are reflected in the page group selected in FIG. 10. In FIG. 10, one print job contains three page groups (1 to 10, 11 to 20, and 21 to 30). When the user selects only the first page group (1 to 10) in FIG. 10, the first page group reflects changes in the print process conditions in FIG. 12. When the user selects all the first to third page groups (1 to 10, 11 to 20, and 21 to 30) in FIG. 10, all the page groups reflect the changes in the print process conditions in FIG. 12.

It is also possible to change the start and end pages. At the same time, the start and end pages of an application range adjacent to the setting-changed application range are also changed. For example, in FIG. 10, one print job is made up of three page groups. The first page group (1 to 10) may be selected to change its end page to the 15th page. The second page group starts from the 11th page, but its start page is changed in accordance with change of the end page of the first page group. More specifically, the start page of the second page group changes to the 16th page.

In the above description, print process conditions are set in advance for a print job, and the preset print process conditions are changed in the window of FIG. 12, but the present invention may take another form. More specifically, print process conditions may be newly set in the window of FIG. 12 without setting any print process conditions in advance for a print job.

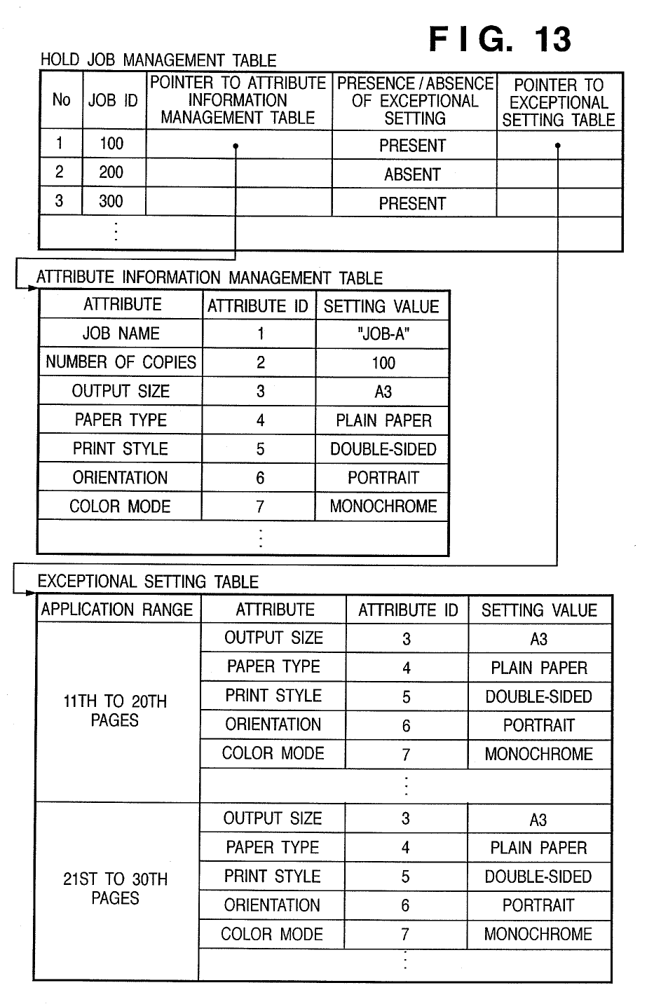

FIG. 13 is a table showing a hold job management table for managing a job stored in the hold queue in an image forming apparatus. The hold job management table contains No., a job ID, a pointer to an attribute information management table, the presence/absence of an exceptional setting, and a pointer to an exceptional setting table.

An attribute information management table stores each attribute information of a job. The attribute information contains an attribute ID and setting value. An exceptional setting table stores exceptional setting information. The exceptional setting information contains an application range, attribute ID, and setting value.

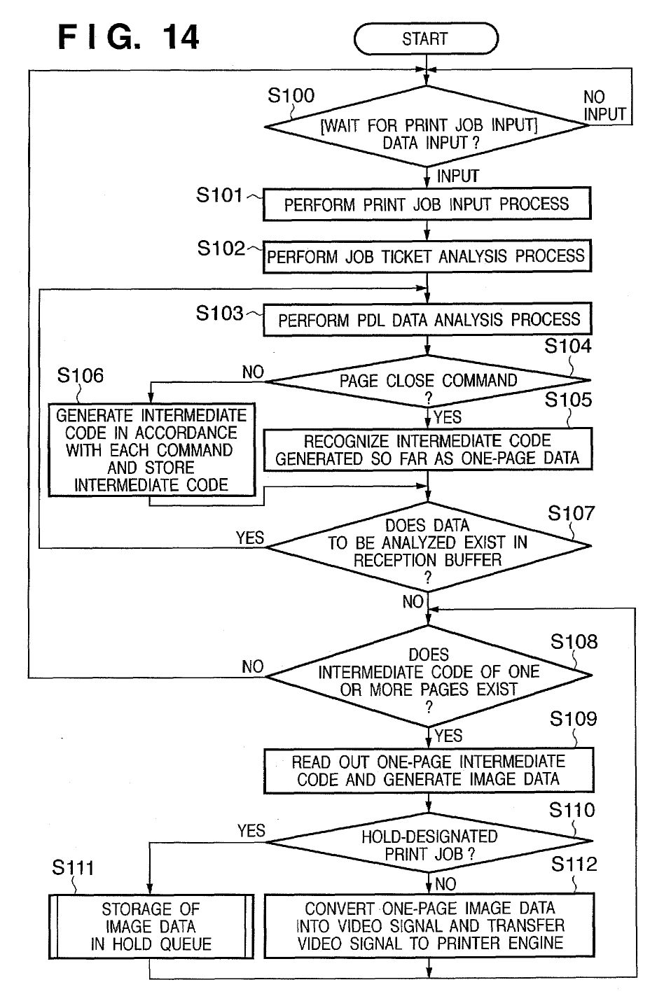

FIG. 14 is a flowchart for explaining the sequence of the main process by the printing apparatus according to the first embodiment.

After power-on, the process enters a print job input standby loop in step S100. When a network-connected host computer inputs a print job, the process escapes from the print job input standby loop in step S100, and shifts to step S101.

In step S101, a print job input process is done. The job ticket analysis unit 122 receives the input print job. In step S102, the job ticket analysis unit 122 analyzes the job ticket. After analyzing the job ticket, the reception buffer 123 stores the print job (PDL data in the first embodiment). The hold job management table stores contents described in the job ticket, and print process condition information of the print job is managed for each job.

In step S103, the job ticket analysis unit 122 analyzes the PDL data stored in the reception buffer 123. Details of the PDL data analysis process will be described later.

If the command is a page close command (or command representing the end of one page) in step S104 (YES), the process advances to step S105 to recognize an intermediate code generated so far as one-page data. The intermediate code is managed for each page, as described above. If the command is one other than the page close command in step S104 (NO), the process advances to step S106 to generate an intermediate code of a form suited to an internal process in accordance with the command.

In step S107, it is checked whether data to be analyzed exists in the reception buffer 123. If data to be analyzed exists (YES), the process returns to step S103 to repeat the PDL data analysis process. If no data to be analyzed exists in the reception buffer 123 (NO), the process advances to step S108.

In step S108, it is checked whether an intermediate code of one or more pages exists. If an intermediate code of one or more pages exists (YES), the process advances to step S109 to read out a one-page intermediate code from the intermediate buffer and generate image data (bitmap) from the intermediate code.

In step S110, it is determined whether the print job is a hold-designated one. If the print job is a hold-designated one (YES), the hold queue 129 stores the generated image data. If the print job is not a hold-designated one (NO), the image buffer 127 stores the image data.

In step S112, one-page image data is read out from the image buffer 127 and converted into a video signal, which is transferred to the printer unit (engine) 118. By transferring the video signal to the printer unit 118, the printer unit 118 actually prints on a sheet and delivers it. Upon completion of sheet delivery, the process returns to step S108. If no one-page intermediate code is complete in step S108, the process returns to step S101 to wait for subsequent input data.

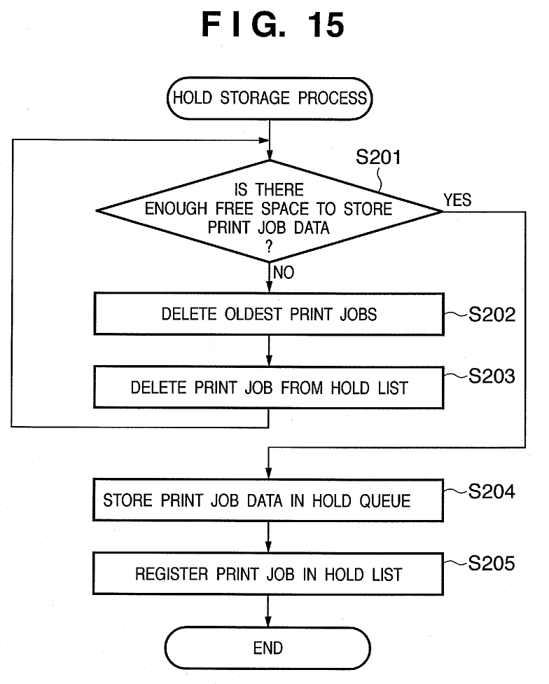

FIG. 15 is a flowchart for explaining details of a hold storage process in step S111. In step S201, it is determined whether there is enough free space available to store the print job data. If there is sufficient free space (YES), the process advances to step S204. If there is not sufficient free space (NO), the oldest print job stored in the hold queue 129 is deleted. The print job is also deleted from the hold list (step S203). After the deletion, the process returns to step S201 again to determine whether there is sufficient free space. These processes are repeated until there is sufficient free space.

If it is determined in step S201 that there is sufficient free space (YES), the hold queue 129 stores print job data in step S204, and the hold list registers the job in step S205.

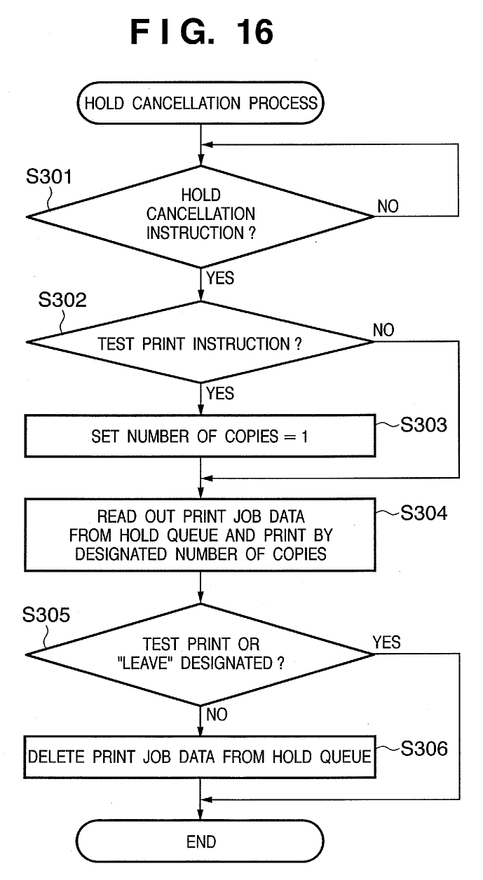

FIG. 16 is a flowchart for explaining details of a hold cancellation process to print data stored in the hold queue 129 in step S111.

In FIG. 16, step S301 is a loop for waiting for a hold cancellation instruction from a user. The process escapes from the loop in response to an instruction (pressing of the “print” button or pressing of the “test print” button) from the user by an operation to the window shown in the schematic view of the touch panel portion (hold list) in FIG. 9. If the hold cancellation instruction is a “test print” instruction in step S302, the process advances to step S303 to set the print count of actual printing to “1” (without changing any print process conditions of the print job). If the hold cancellation instruction is not a “test print” instruction in step S302, the process advances to step S304.

In step S304, image data is read out from the hold queue 129 and a set number of copies are printed. Upon completion of printing, if test printing or “leave” (not shown) is designated for the job in step S305 (YES), the job data is not deleted. If NO in step S305, the job data is deleted.

The following operation is done when a print job to be printed in step S304 comprises a plurality of page groups and the page groups have different print process conditions. For example, when printing a print job of three page groups shown in FIG. 10, the first page group (1 to 10) undergoes a single-sided print process with paper size “A4”, paper type “plain paper”, and orientation “landscape”. The second page group (11 to 20) undergoes a single-sided print process with paper size “A3”, paper type “plain paper”, and orientation “landscape”. The third page group (21 to 30) undergoes a double-sided print process with paper size “A4”, paper type “glossy paper”, and orientation “portrait”. That is, when printing a print job made up of a plurality of page groups, the MFP control unit 108 causes the printer unit 118 to print under print process conditions set for each page group.

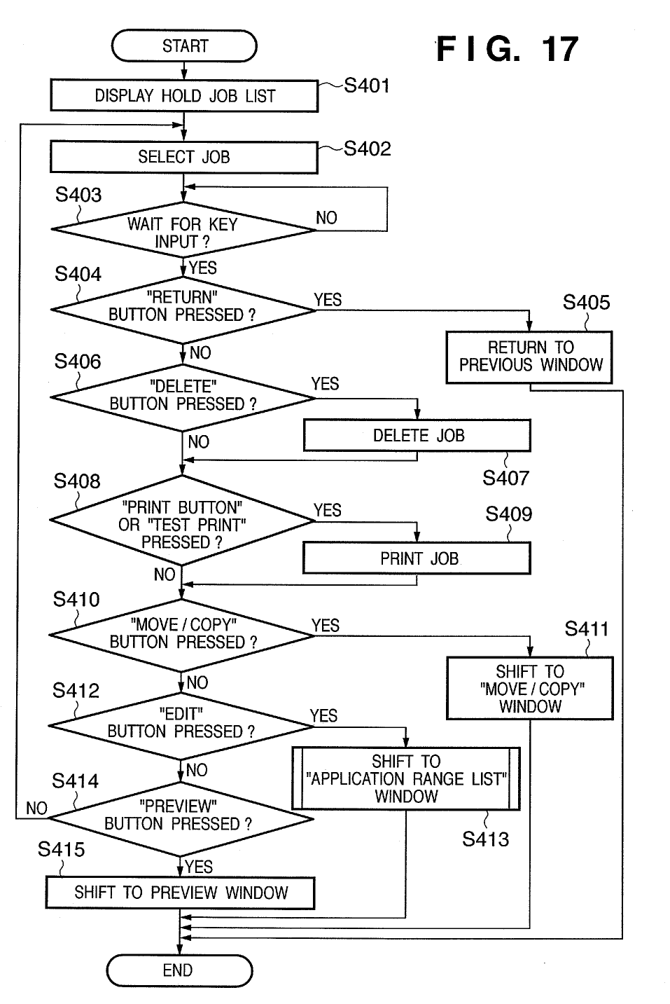

FIG. 17 is a flowchart for explaining a hold list display process by controlling the window shown in the schematic view of the touch panel portion (hold list) in FIG. 9.

A list of hold jobs stored in the hold queue 129 is displayed in accordance with information from the hold job management table (step S401). In step S402, a user selects a job. The user can select one or a plurality of jobs from the displayed list. In an initial state, the start list job is displayed.

In step S403, the process waits for a key input. If a key input is received (YES), the process advances to step S404. In step S404, it is checked whether the user has pressed the “return” button. If the user has pressed the “return” button (YES), the process advances to step S405 to return to the previous window. If the user has not pressed the “return” button (NO), it is checked in step S406 whether the user has pressed the “delete” button. If the user has pressed the “delete” button (YES), the job is deleted (step S407). In the process of step S407, information is deleted from the hold job management table, and at the same time, image data is deleted from the hold queue 129.

If the user has not pressed the “delete” button in step S406 (NO), it is checked in step S408 whether the user has pressed the “print” or “test print” button. If the user has pressed the “print” or “test print” button (YES), the process complies with the sequence described in the flowchart of the hold cancellation process in FIG. 16 (step S409).

It is checked in step S410 whether the user has pressed the “move/copy” button. If the user has pressed the “move/copy” button (YES), the “move/copy” window is displayed (step S413). If the user has not pressed the “move/copy” button (NO), the process advances to step S412 to check whether the user has pressed the “edit” button. If the user has pressed the “edit” button (YES), the window shown in the schematic view of the touch panel portion (application range list) in FIG. 10 is displayed.

In step S414, it is checked whether the user has pressed the “preview” button. If the user has pressed the “preview” button (YES), a preview window is displayed (step S415).

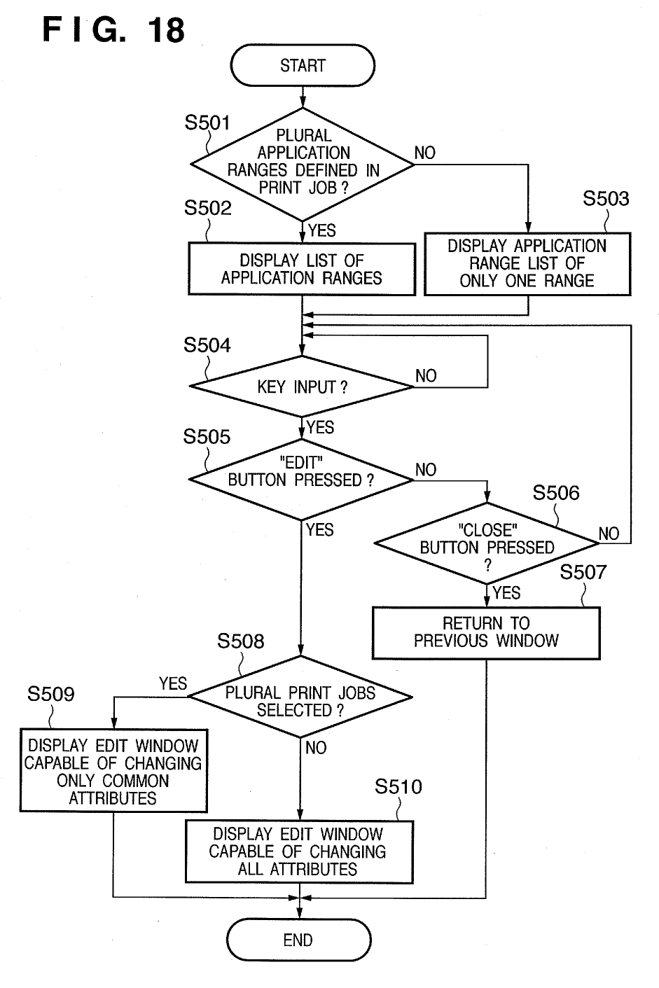

FIG. 18 is a flowchart for explaining an application range list display process by controlling the window shown in the schematic view of the touch panel portion (application range list) in FIG. 10 or 11.

It is checked whether a plurality of application ranges are defined in the job (step S501). This process refers to the “presence/absence of an exceptional setting” information in the hold job management table. If the job has an exceptional setting (YES), the process advances to step S502; if no job has an exceptional setting (NO), to step S503.

In step S502, a list of ranges is displayed (see the schematic view of the touch panel portion (application range list) in FIG. 10). In step S503, a list of only one application range is displayed (see the schematic view of the touch panel portion (application range list) in FIG. 11).

In step S504, it is determined whether a key input is received via the application range list window. If a key input is received (YES), the process advances to step S505 to check whether the user has pressed the “edit” button. If the user has pressed the “edit” button (YES), the process advances to step S508. If the user has not pressed the “edit” button (NO), the process advances to step S506.

In step S508, it is checked whether the user has selected a plurality of print jobs in the window in the schematic view of the touch panel portion (hold list) shown in FIG. 9. If the user has selected a plurality of print jobs (YES), the process advances to step S509 to display an edit window capable of editing only common print process conditions (print process conditions having the same values between print jobs). If the user has not selected a plurality of print jobs (NO), an edit window capable of changing all print process conditions is displayed (step S510).

In step S506, it is determined whether the user has pressed the “close” button. If the user has pressed the “close” button (YES), the process advances to step S507 to return to the previous window. If the user has not pressed the “close” button (NO), the process returns to step S504.

### Second Embodiment

In the first embodiment, the client PC 200 or print server 300 inputs a print job. The second embodiment uses a scanner unit to input a print job.

The second embodiment will describe a scanner unit using an ADF (Auto Document Feeder), but is also applicable to a scanner unit which receives sheets one by one from the platen.

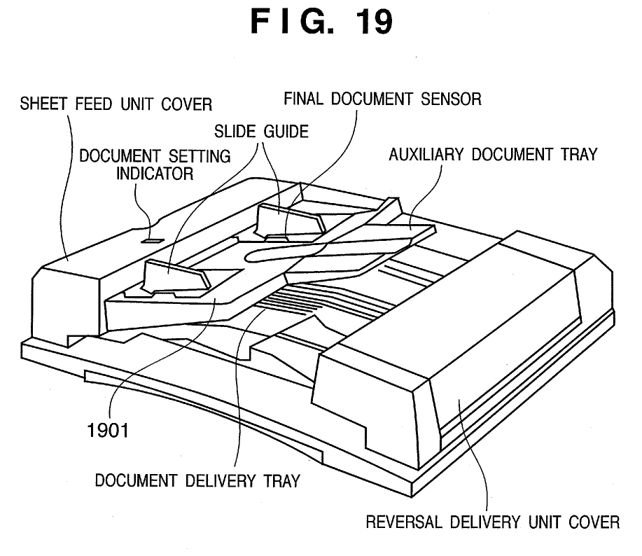

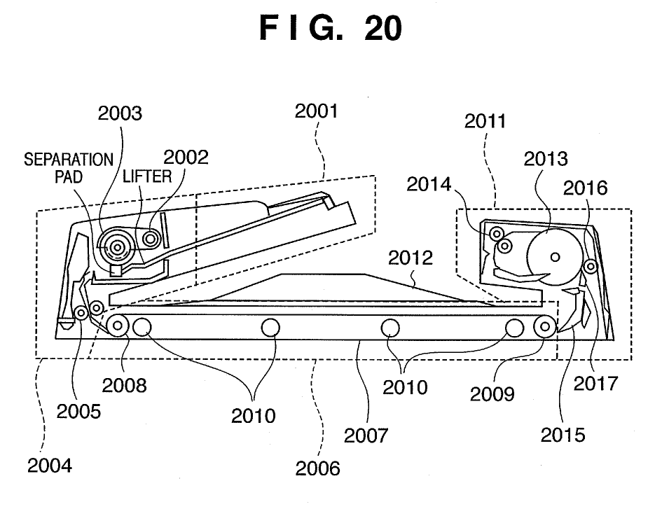

FIGS. 19 and 20 are perspective and sectional views, respectively, showing the structure of the ADF employed in the second embodiment.

In FIGS. 19 and 20, a document is set on the support surface of a document tray 1901 in a document stacking section 2001. A document sensor detects that the document is set. The document sensor is interposed between pickup rollers 2002 and a sheet feed roller 2003 (to be described later).

A sheet feed section 2004 separates one top sheet from a document bundle by frictional separation, and conveys the sheet to registration rollers 2005. When feeding a document sheet, the pickup rollers 2002 move down onto a document bundle, and an intermediate plate moves up to press the document bundle against the sheet feed roller 2003, entering a preliminary sheet feed operation. The sheet feed roller 2003 and pickup rollers 2002 rotate CW (ClockWise) using a motor as the driving source, thereby conveying the document sheet. The second and subsequent document sheets, which are to be fed together with the top sheet, stand still by a friction piece and stay in the document stacking section 2001. A separation sensor arranged downstream from the sheet feed roller 2003 detects separation of the document sheet.

The document sheet passes between guide plates and is guided to a pair of registration rollers. The pair of registration rollers stops when the leading end of the document sheet reaches them. The sheet feed roller 2003 conveys the document sheet to form a loop and correct skew, and then the document sheet is conveyed to a conveyance section 2006.

In the conveyance section 2006, a conveyance belt 2007 is looped between a driving roller 2008 and a driven roller 2009. The conveyance belt 2007 turns while pressed against the platen (document table) by press rollers 2010. When a document sheet comes between the conveyance belt 2007 and the platen, it is conveyed on the platen by the frictional force of the conveyance belt 2007.

The document sheet entering the conveyance section 2006 from the sheet feed section 2004 is conveyed to a predetermined position on the platen by the conveyance belt 2007, stops along with the stop of a driving motor (not shown), and is read by a document reader. After the end of reading, the document sheet is conveyed right in FIG. 20 by re-driving of the driving motor, and guided to a reversal delivery section 2011.

When a subsequent document sheet remains, it is conveyed to the predetermined position by the turn of the conveyance belt 2007, stops at the reading position along with the stop of the driving motor, and is read by the document reader, similar to the preceding document sheet. During reading, the preceding document sheet is reversed by the independently operating reversal delivery section 2011, and conveyed to a document delivery/stacking section 2012.

The reversal delivery operation will be explained.

The reversal delivery section 2011 comprises a reverse roller 2013 and a pair of conveyance rollers 2014 as a conveyance means, and comprises a motor (not shown) as their driving source. The motor can rotate forward and backward. This motor can drive the reversal delivery section 2011 independently of the conveyance section 2006 driven by another motor.

A document delivery operation by the reversal delivery section 2011 will be explained.

When a document sheet enters the reversal delivery section 2011 by the conveyance belt 2007, a reverse flapper 2015, which regulates the traveling path of a sheet near the entrance, takes a posture shown in FIG. 20 under the control of a solenoid (not shown) to guide the document sheet to the reverse roller 2013. The document sheet is clamped between the reverse roller 2013 which rotates CCW (CounterClockWise), and an opposing reverse roller 2016, and conveyed to the pair of conveyance rollers 2014.

After the trailing end of the document sheet passes the delivery flapper 2017, the delivery flapper 2017 pivots CW, and the reverse roller 2013 rotates in the reverse direction CW, starting switchback conveyance of the document sheet. The document sheet is guided to a lower left portion of the reverse roller 2013 in FIG. 20, and discharged onto the document delivery tray of the document delivery/stacking section 2012.

For example, when a document has sheets of different sizes, a document bundle of each paper size is set on the ADF in most cases. When the number of document sheets is large and they cannot be read at once, a document bundle of each chapter may be set on the ADF. In this case, the printing apparatus according to the second embodiment has a mode in which the print process condition application range is automatically set for each document bundle (one set of document sheets on the ADF).

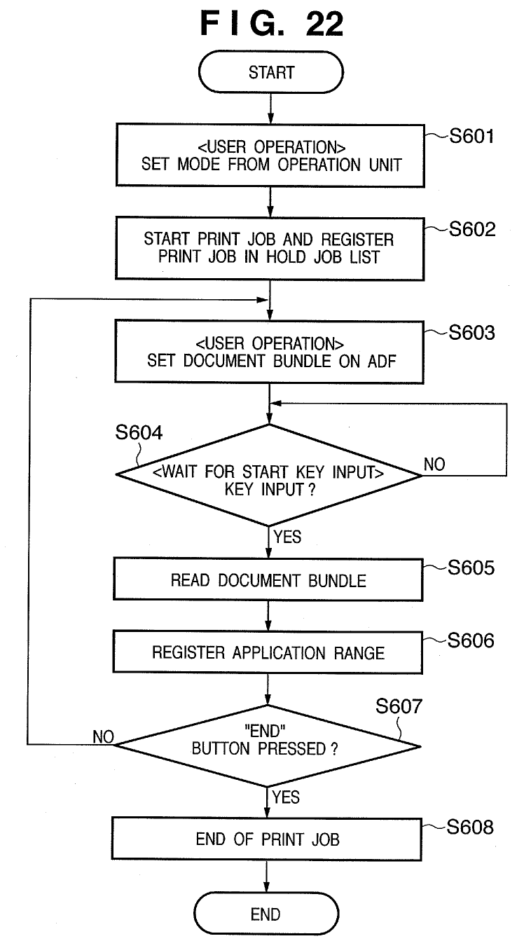

FIG. 22 is a flowchart for explaining the process to successively read divided document bundles from the ADF, and store their data as one print job in the hold queue.

Step S601 is a user operation to select, from the operation unit, the mode in which document bundles are successively read and their print job is registered in the hold queue. In step S602, registration of the print job starts. The hold queue list registers the print job. At this time, the print process conditions of the job stored in the hold list comply with settings on the operation unit.

Step S603 is a user operation to set a document bundle on the ADF. Step S604 is a key input standby loop to wait for press of the start key. If the user presses the start key (YES), the process advances to step S605.

In step S605, the ADF reads the image of each page of the document bundle as image data. The read image data is stored in the hold queue. At this time, the number of read pages of the document bundle is counted, and the document size is automatically detected. It is also possible to set print process conditions such as the paper type from the operation unit for each document bundle.

In step S606, the hold list registers the print process condition setting application range for each document bundle read in step S605. In step S607, it is determined whether the user has pressed the “end” button. If the user has pressed the “end” button (YES), the process advances to step S608 to end the job. If the user has not pressed the “end” button (NO), the process returns to step S603 to set the next document bundle.

For example, when steps S603 to S607 are repeated three times to read three document bundles, a print job of three page groups is input.

In some cases, the user wants to change the paper type after reading even with the same paper size. For example, the user wants to print a cover with a paper type (e.g., thick paper) different from that of the body after reading the entire document. In this case, the user adopts a mode different from the above-described mode in which the application range is set for each document bundle. That is, the entire document is read with one application range, and then application ranges are set later.

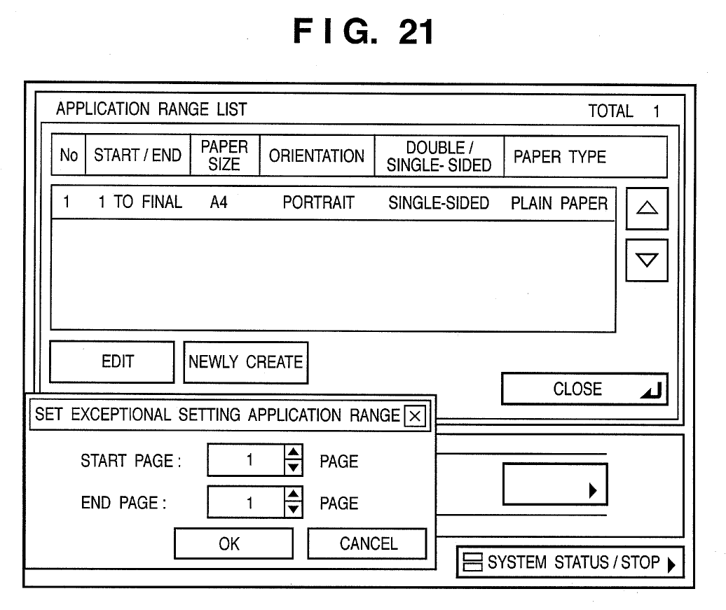

FIG. 21 is a schematic view of an example of the window of a touch panel portion (application range list) displayed in the printing apparatus according to the second embodiment. The second embodiment can newly add a print process condition application range from the window shown in FIG. 21. More specifically, when a user presses a “newly set” button in the schematic view of the touch panel portion (application range list) in FIG. 21, a popup window for setting an application range (start and end pages) appears, and the user inputs start and end pages. The user presses the OK button to add the application range to the application range list. The initial values of print process conditions are the same as those of the settings of the whole. The user can select an application range in this state to change print process conditions.

For example, after reading a 30-page document bundle and displaying the window shown in FIG. 21, the user sets “1” as the start page of an application range and “10” as the end page, thereby dividing the document bundle into the first page group of 1st to 10th pages and the second page group of 11th to 30th pages. The user selects the second page group in the window of FIG. 21 and sets “11” as the start page of an application range and “20” as the end page, thereby dividing the page group into the second page group of 11th to 20th pages and the third page group of 21st to 30th pages. In this way, the 30-page document bundle can be read at once and divided into a plurality of page groups to generate one print job.

### Third Embodiment

The first embodiment has described the print process condition change method using the windows of FIGS. 9 to 12. The third embodiment will explain another print process condition change method.

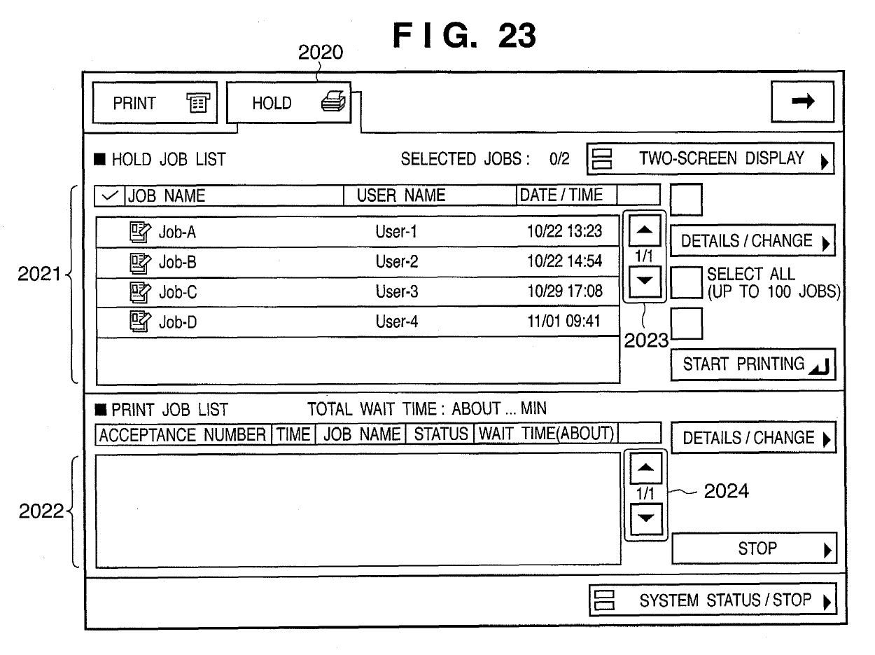

FIG. 23 shows a modification of the window in FIG. 9. FIG. 23 shows a window displayed when selecting a “hold list” 2020 by a user operation in a window displayed on an operation unit 120 of a printing apparatus. A hold queue serving as part of the storage area of a document management unit 114 in an MFP 100 stores a print job hold-designated by a printer driver. A “hold job list” 2021 is a list of jobs stored in the hold queue. The “hold job list” 2021 displays the print process conditions of each print job (e.g., a job name, a user name, the number of pages, and a date and time when the job is stored). The contents of the displayed print process conditions comply with job ticket information generated by the printer driver.

A print job list 2022 is displayed at a lower portion in the display window of FIG. 23, and allows a user to confirm the print status of a print job when the hold job undergoes a print process.

Up/down scroll keys 2023 and 2024 in FIG. 23 are used to scroll the window and confirm all jobs when the hold job list and print job list cannot display all print jobs.

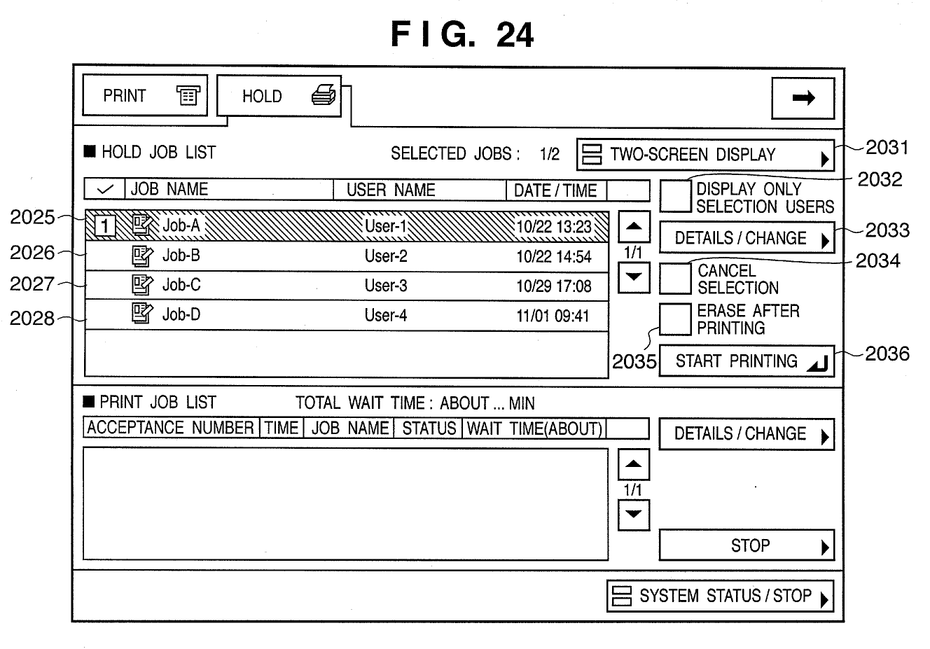

A user clicks Job-A while displaying the window of FIG. 23 on the operation unit 120, and the window switches to that of FIG. 24 to select Job-A 2025. This operation is a toggle operation, so the user clicks the Job-A 2025 again to cancel selection of the Job-A.

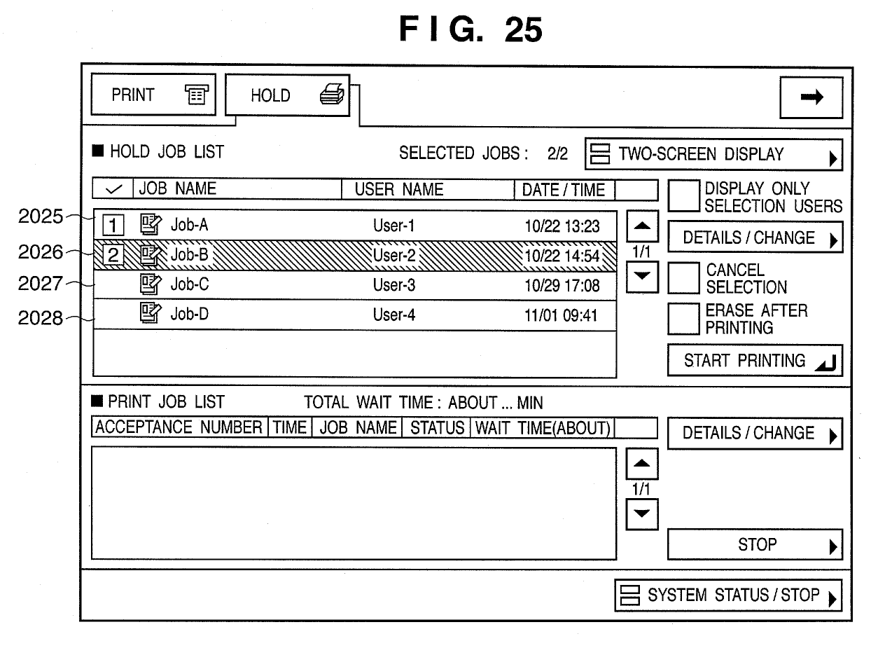

The user clicks Job-B 2026 while selecting the Job-A 2025, and the window switches to that of FIG. 25 to display “1” and “2” in the order in which the jobs were selected.

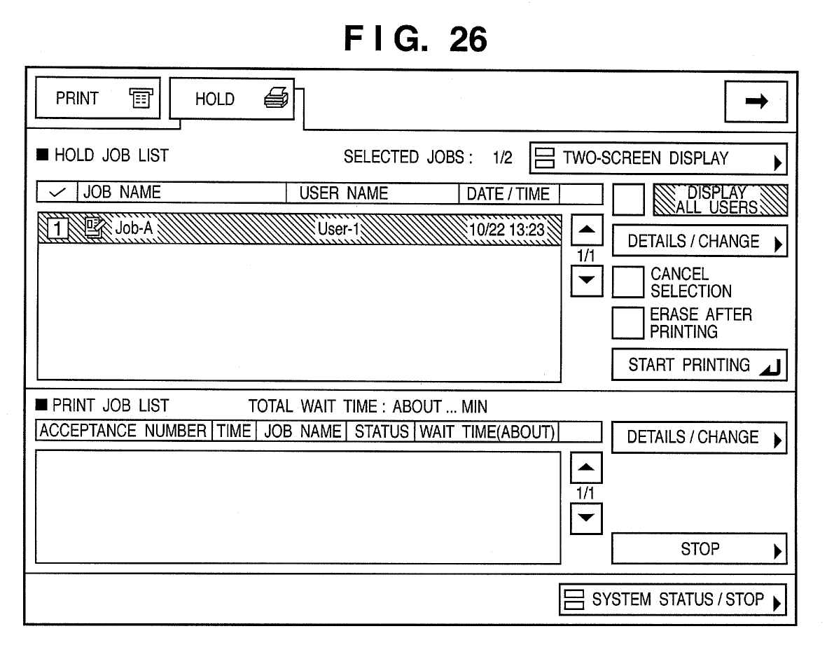

A user selection key 2032 in FIG. 24 is used to display only jobs whose users coincide with the user of the currently selected job (Job-A in FIG. 24). The user clicks the user selection key 2032 in the window of FIG. 24, and the window switches to that of FIG. 26 to display only print jobs input by User-1. The user clicks the user selection key 2032 again in the window of FIG. 26, and the window returns to that of FIG. 24.

A job selection key 2034 in FIG. 24 operates as a select-all key for selecting all print jobs when clicked while no print job is selected. If the user clicks the job selection key 2034 while selecting one or more print jobs, the job selection key 2034 functions as a selection cancellation key for canceling a selected job.

An after-erase key 2035 in FIG. 24 is used to set in advance erase of a print job from the hard disk after a print process when executing the print process based on the selected print job. If the user designates printing while selecting the after-erase key 2035, the designated print job is erased from the hold job list after the print process. If the user designates printing without selecting the after-erase key 2035, the designated print job enters the hold queue again after the print process and is displayed in the hold job list again.

A print start key 2036 is used to designate execution of a print process for a selected print job in the hold job list 2021.

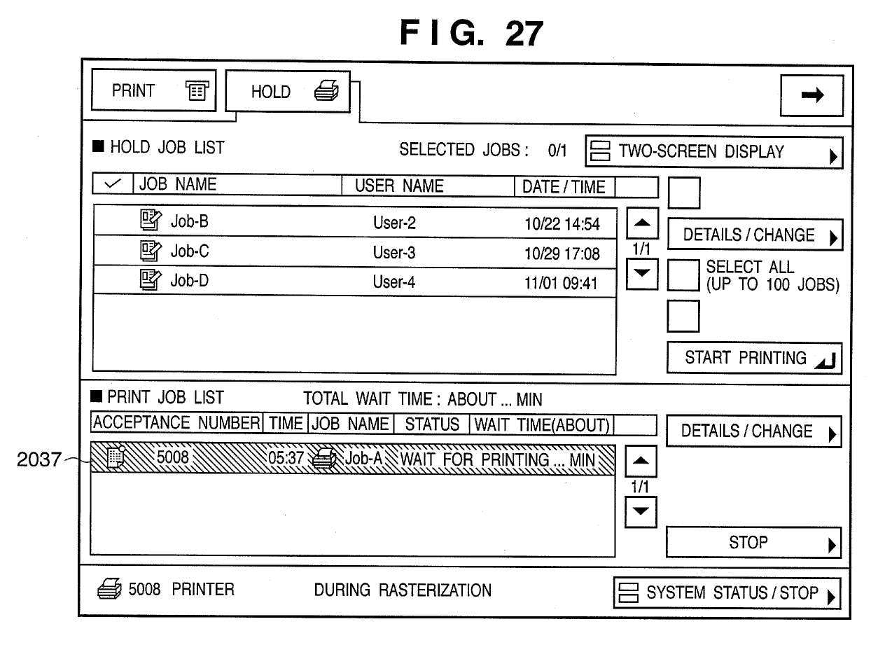

The user clicks the print start key 2036 in the state of FIG. 24, and the window switches to that of FIG. 27 to designate a print process based on the selected job 2025 and change to a print standby state 2037. When a printer unit 118 becomes ready, the print process starts.

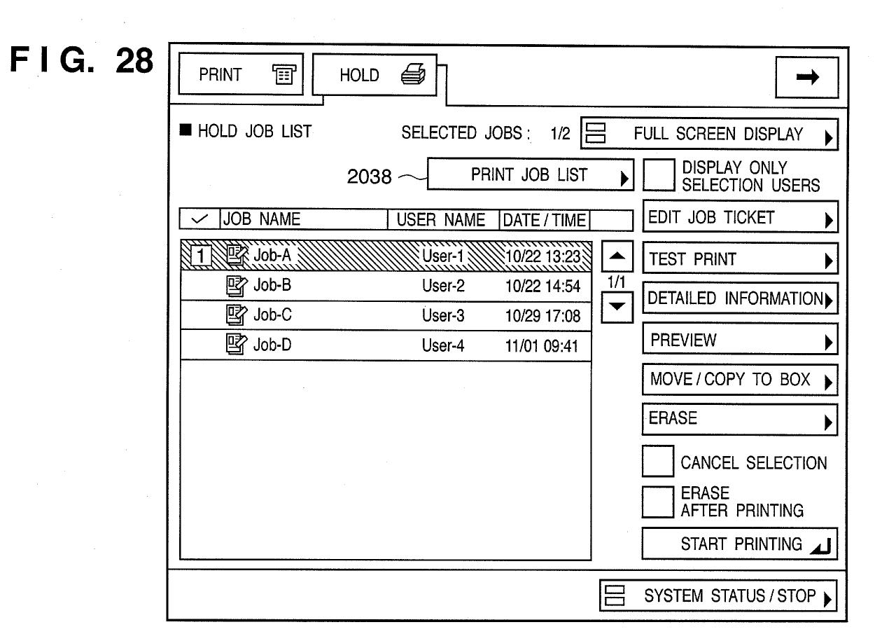

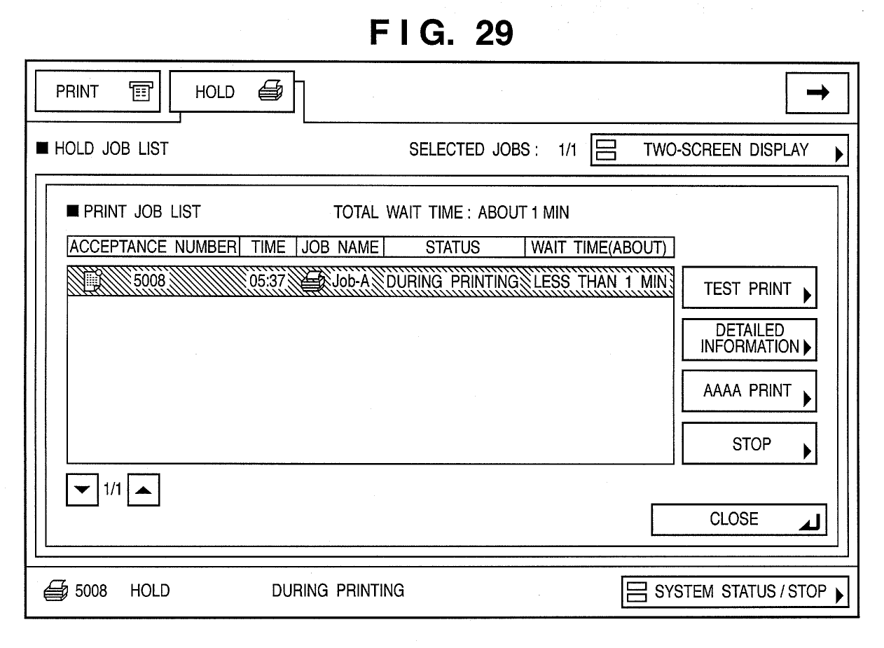

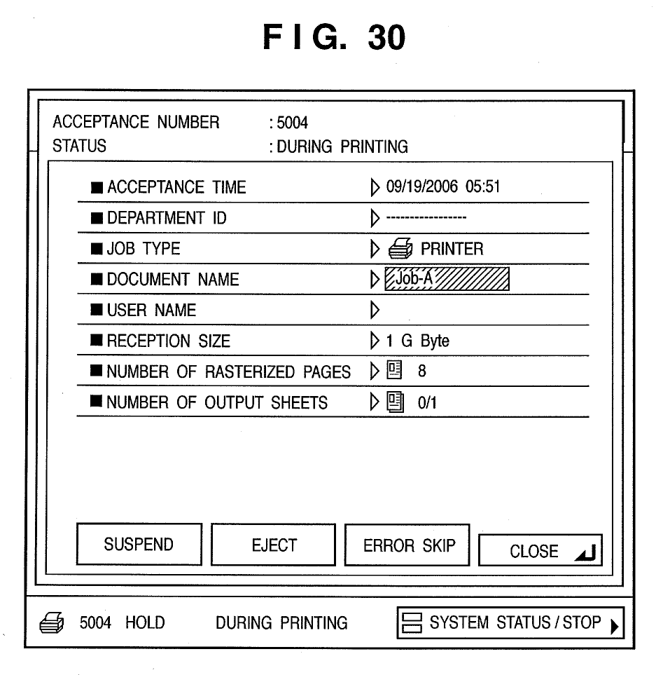

The user clicks a display switch key 2031 in the window of FIG. 24, and the window switches to that of FIG. 28 to display only the hold job list 2021. The user clicks a print job list 2038 in the window of FIG. 28, and the window switches to that of FIG. 29 to display only the print job list 2022. The user clicks the detailed information key in the window of FIG. 29 to switch the window to that of FIG. 30, and can confirm detailed information on a print job during a print process.

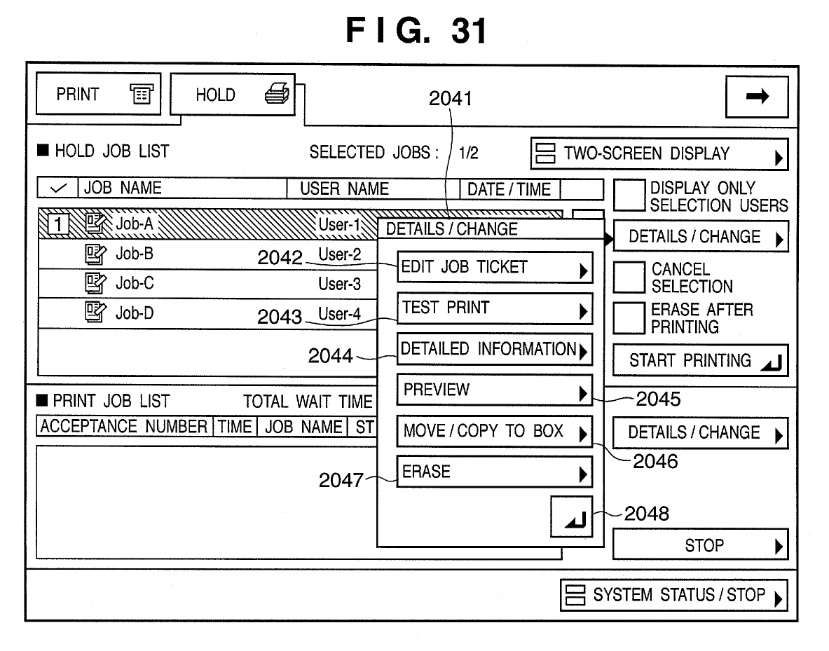

The user clicks the details/change key 2033 in the window of FIG. 24, the window switches to that of FIG. 31, and a popup window 2041 appears. The popup window 2041 provides a job ticket edit key 2042 for changing print process condition information (job ticket) of a selected print job, a test print key 2043 for test-printing a selected print job, and a detailed information key 2044 for displaying detailed information on a selected print job. The popup window 2041 also provides a preview key 2045 for displaying the thumbnail image of a selected print job, a move/copy key 2046 for moving a selected job to a box or copying it, an erase key 2047 for erasing a selected job, and a return key 2048 for returning to a previous window.

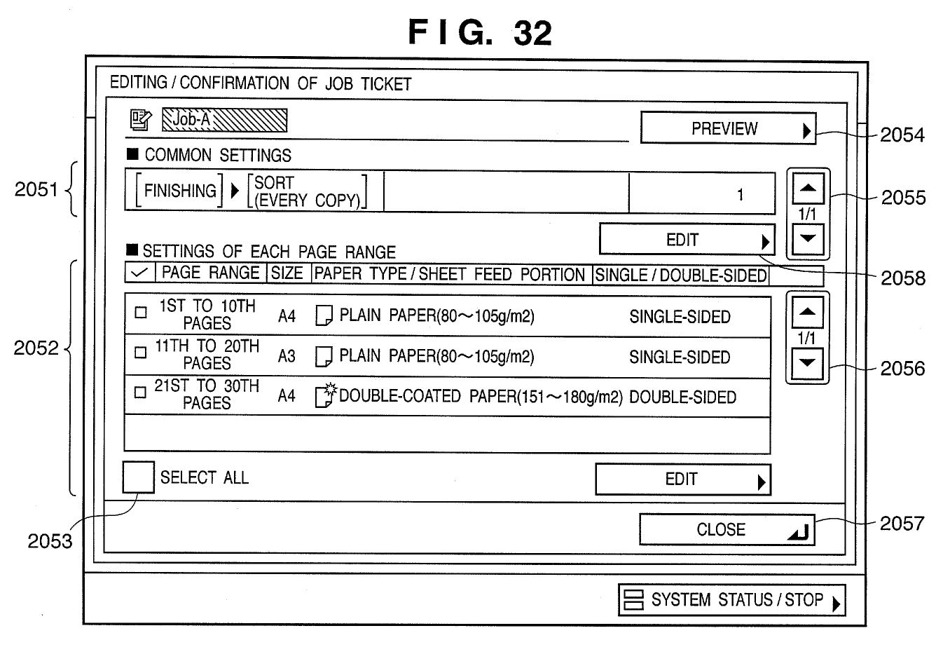

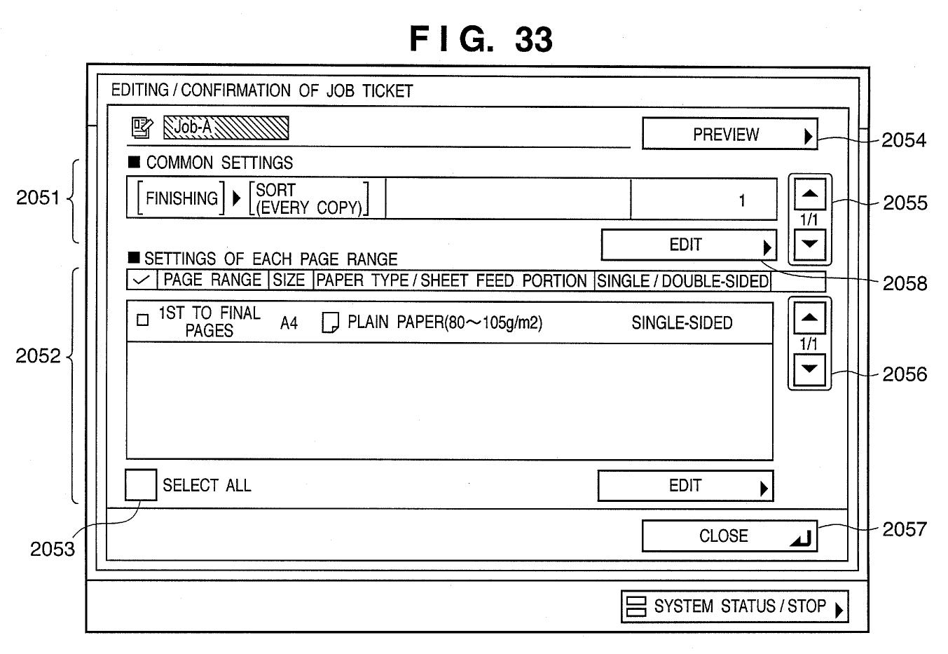

When the user selects Job-A and clicks the job ticket edit key 2042 in the window of FIG. 31, and a plurality of partitions (page ranges having the same print conditions) exist, the window of FIG. 32 is displayed. If the print job is not partitioned, the window of FIG. 33 is displayed.

FIG. 32 shows a window which displays a list of print process condition application ranges (partitions) for a print job. The window of FIG. 32 comprises a common setting portion 2051 which displays the common settings of the print process conditions of a selected job, and a page range setting portion 2052 which displays the settings of each page range. Up/down scroll keys 2055 and 2056 are used to scroll through the print process condition information and display all pieces of the print process condition information when the common setting portion 2051 and page range setting portion 2052 for a job cannot display all pieces of the print process condition information.

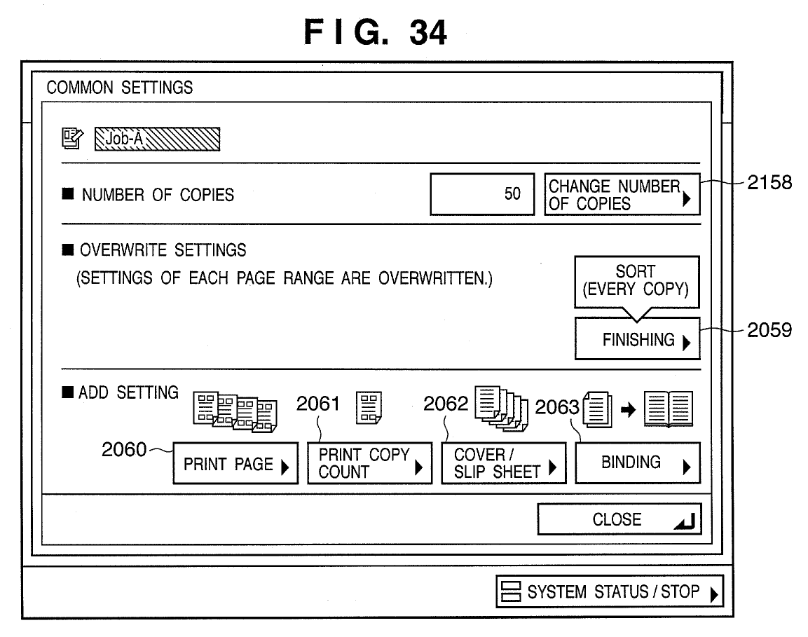

To edit the common setting portion 2051, the user clicks an edit key 2058. Then, the window changes to that of FIG. 34 to allow the user to change the print process condition information on an entire job, such as the number of copies of Job-A, a finishing process, or whether to perform page printing.

For example, the user clicks a copy count change key 2158 to change the number of copies, a finishing key 2059 to change finishing, a page print key 2060 to perform page printing, a copy count print key 2061 to perform copy count printing, a cover/slip sheet key 2062 to set a cover or slip sheet, or a bookbinding key 2063 to perform a bookbinding process.

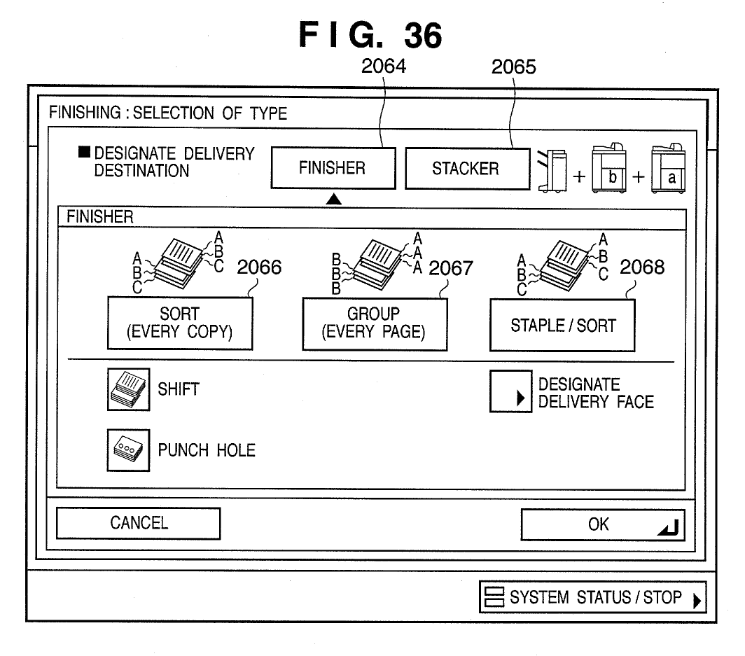

Change of finishing will be described. The user clicks the finishing key 2059, and the window changes to that of FIG. 36. Assume that a finisher is connected though finishing changes depending on a post-processing apparatus connected to the printing apparatus. The user clicks a finisher setting 2064, and a finisher setting popup window appears. The user can select one of sort 2066, group 2067, and staple/sort 2068 as a job output form. In this example, the user selects sort, and the background of sort changes.

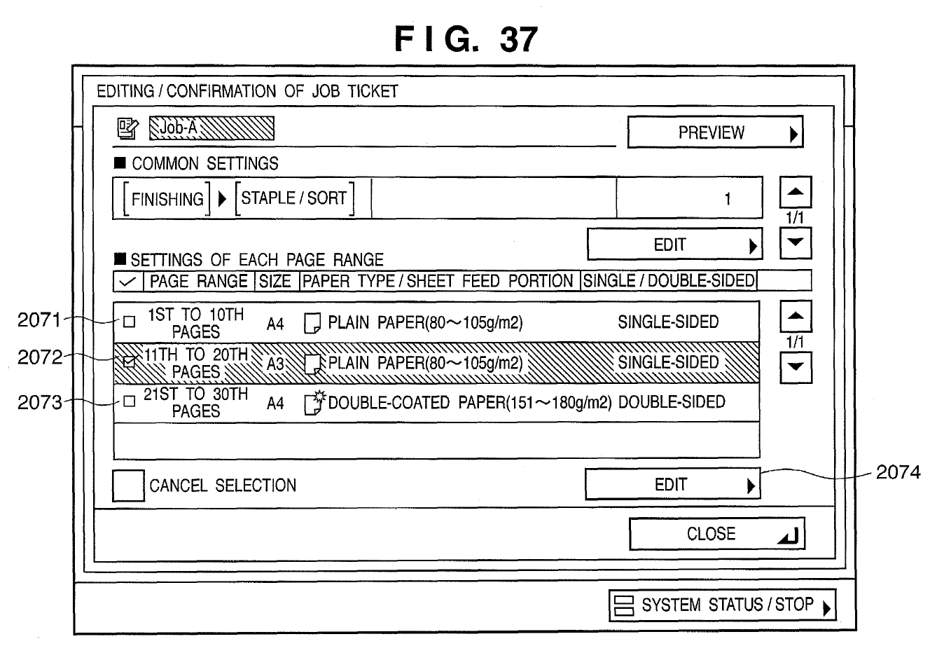

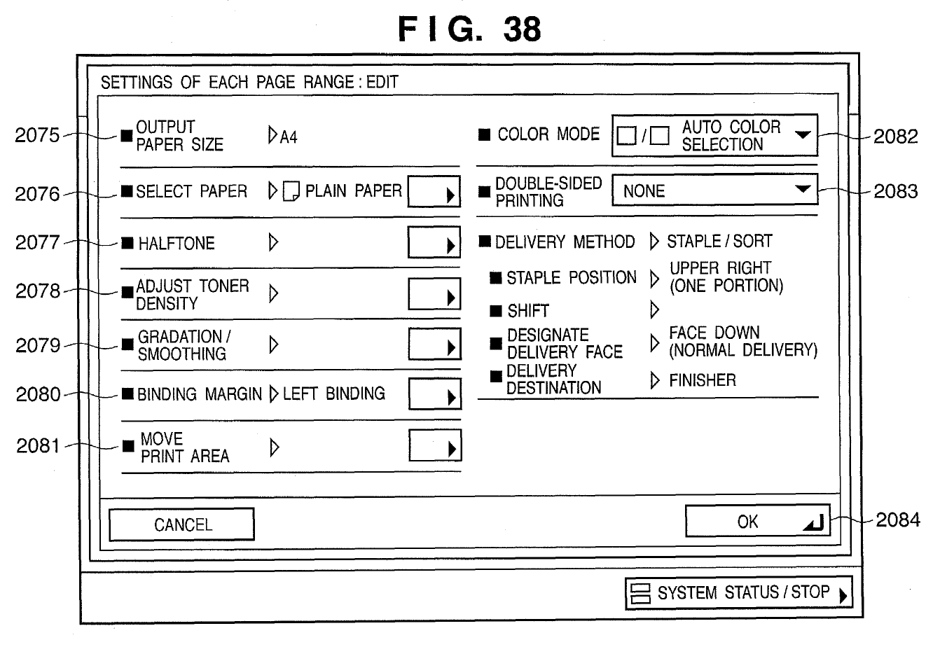

In FIG. 32, the user selects one page range from the settings of respective page ranges (partitions), and the window switches to that of FIG. 37 to check the left check box. At this time, an edit key 2074 for setting each page range appears, the user clicks the edit key 2074, and the window changes to that of FIG. 38.

The window of FIG. 38 is a window for editing the print process condition information of each page range. For example, to change the paper size or type of a selected page range, the user clicks the right key of paper selection 2076. The user can select a halftone 2077 of each page range from resolution priority, tonality priority, error diffusion, and the like.

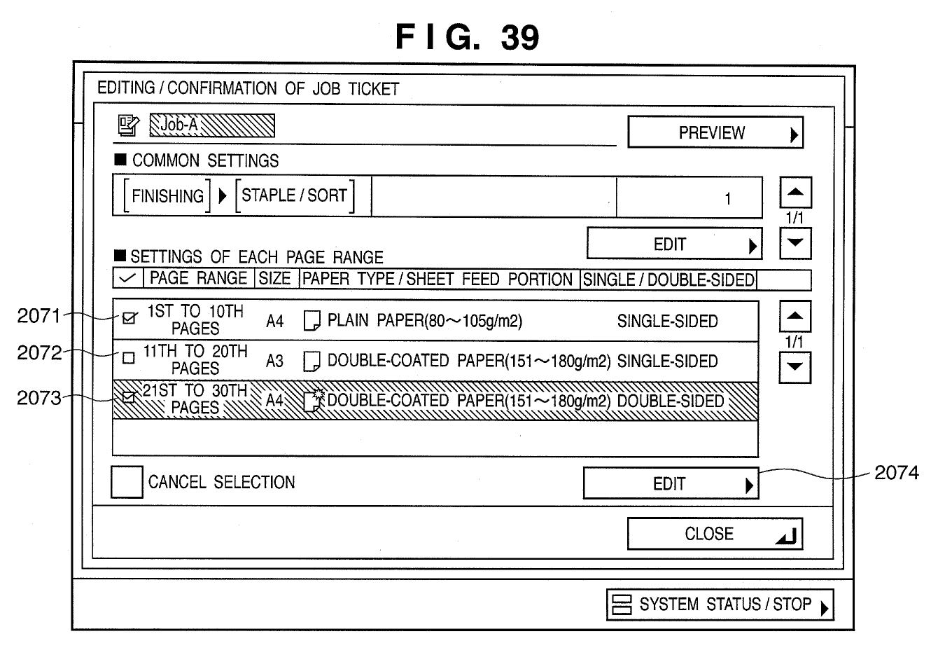

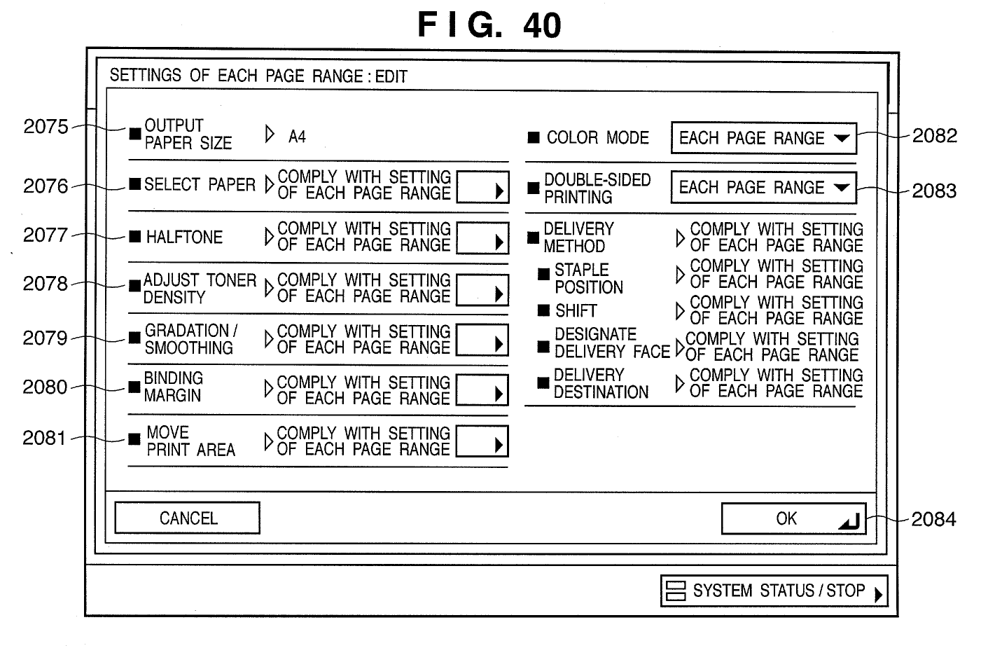

When the user selects two or more page ranges in the window of FIG. 32, the window switches to that of FIG. 39. In FIG. 39, two page ranges are selected. The user clicks the edit key 2074 while selecting two page ranges, and the window switches to that of FIG. 40. Since the settings of the respective page ranges cannot be displayed, “comply with the setting of each page range” is described at each setting item. However, the document management unit 114 manages print process condition information of respective pages.

In this case, when a piece of the print process condition information is rewritten, the print process condition information is rewritten at once in selected page ranges. However, unselected print process condition information is held in the document management unit 114 without changing from the print process condition information set for each page range.

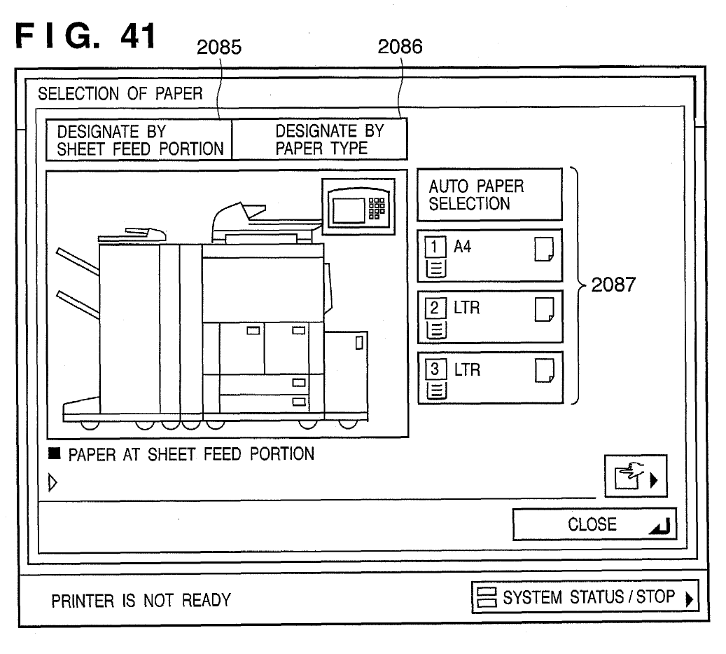

The user clicks the setting change key of paper selection 2076 in the window of FIG. 40, and the window changes to that of FIG. 41. The window of FIG. 41 is a window for changing the paper of a selected page range. The user can click a “designate by a sheet feed portion” key 2085 or a “designate by a paper type” key 2086 to change paper by either selection method.

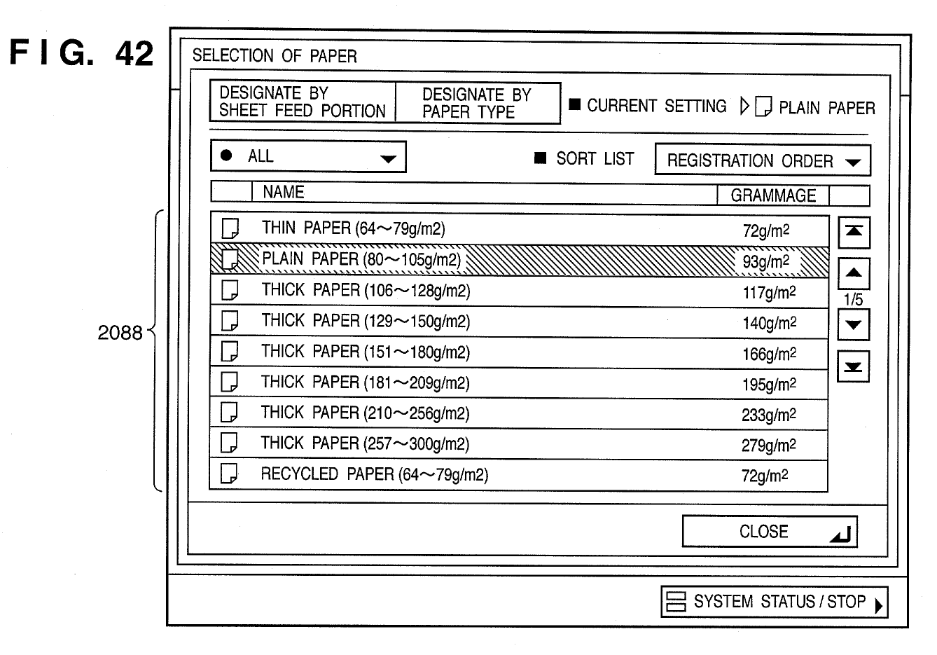

When the user selects the “designate by a sheet feed portion” key 2085, he can select a desired sheet feed portion from sheet feed portion selection keys 2087 in FIG. 41 and select paper corresponding to the selected sheet feed portion. When the user selects the “designate by a paper type” key 2086, the window changes to that of FIG. 42. The user can select a paper type to determine a sheet feed portion by auto paper selection.

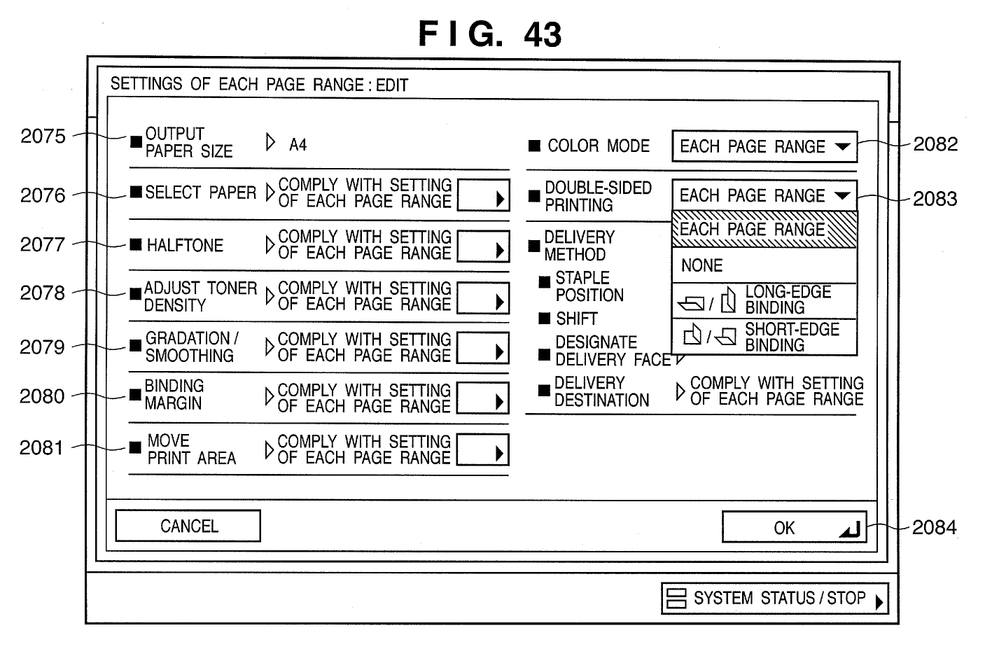

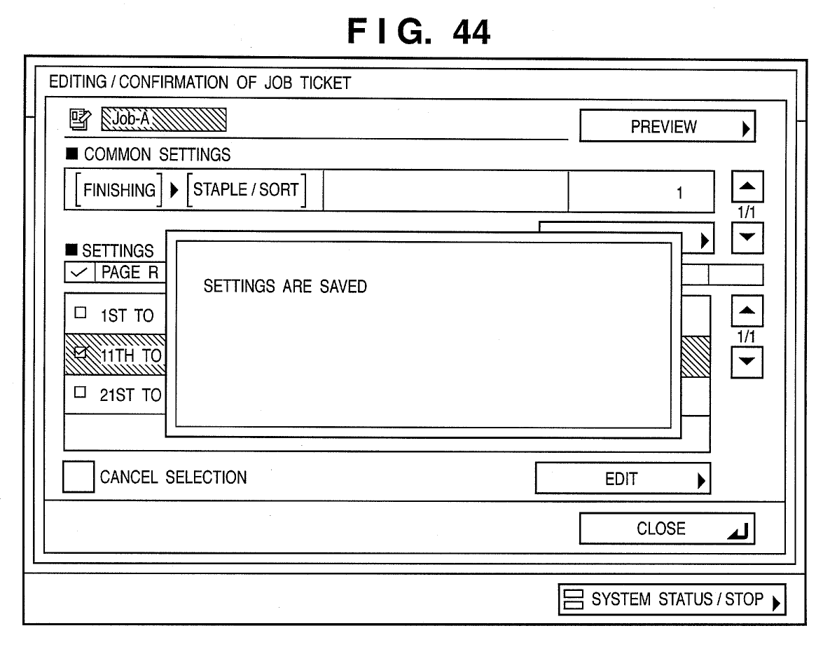

The user clicks the close key in the window of FIG. 42, and the window returns to that of FIG. 38 or 40. Further, the user selects a color mode selection key 2082, single/double-sided printing switch key 2083 (FIG. 43), and the like and clicks the OK key 2084 to save new settings, as shown in FIG. 44. To cancel saving of the settings, the user clicks the cancel key in the window of FIG. 43.

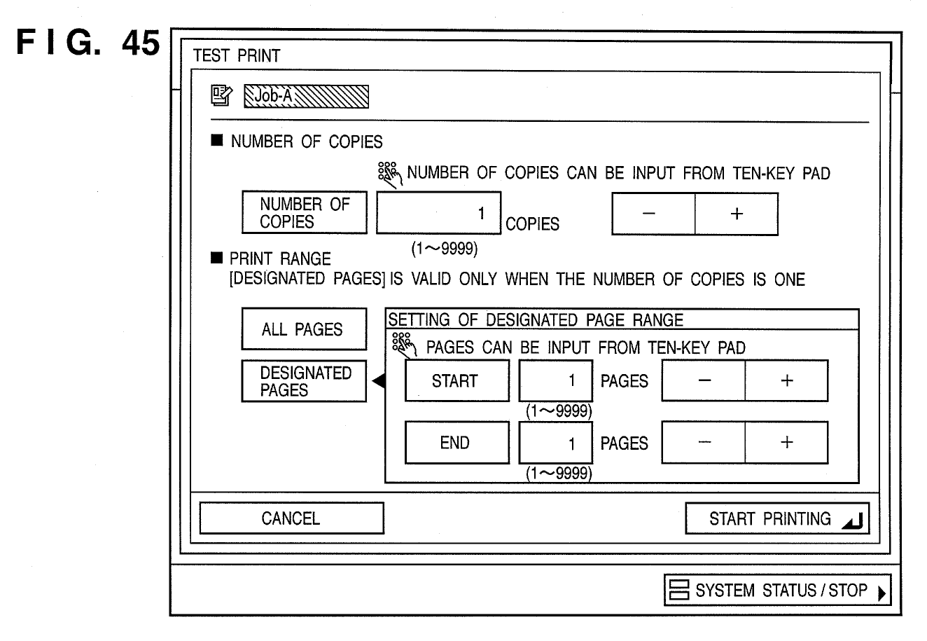

The user clicks the test print key 2043 in the window of FIG. 31, and the window changes to that of FIG. 45. The window of FIG. 45 allows setting test printing. The user can designate the page range to be test-printed, in addition to the number of copies to be test-printed.

The third embodiment does not erase a print job from the hold queue upon completion of test printing. Also, test printing does not decrement the number of copies set for the job.

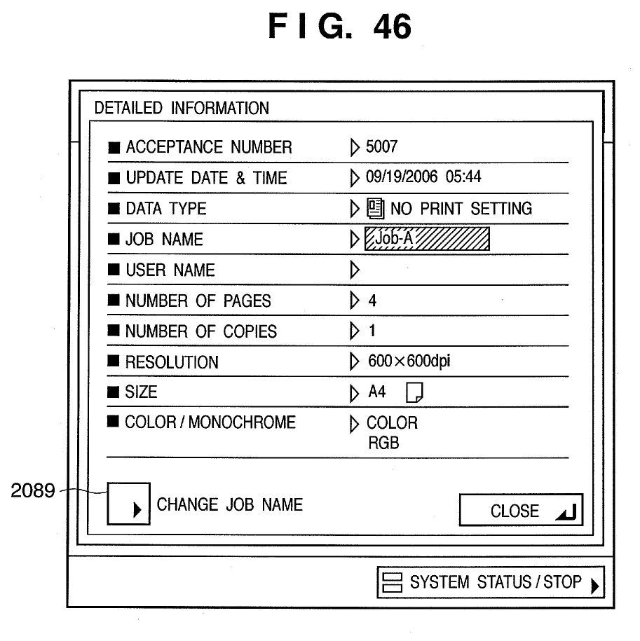

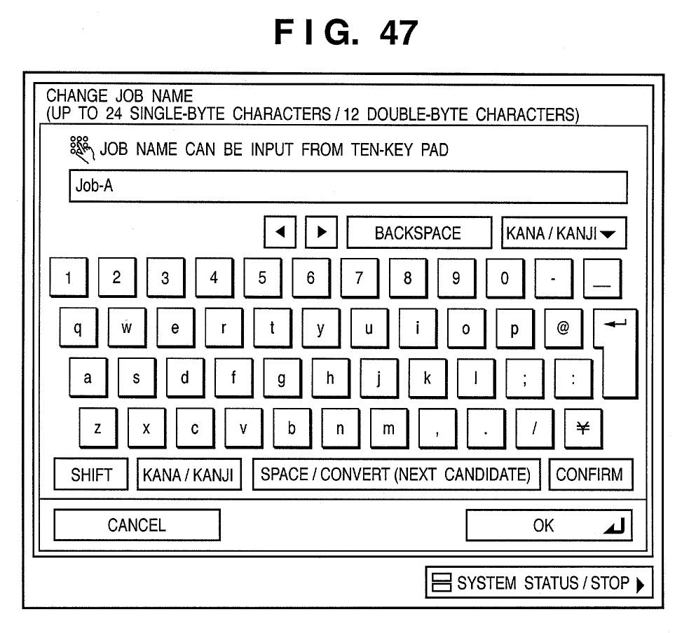

The user clicks the detailed information key 2044 in the window of FIG. 31, and the window changes to that of FIG. 46. The user can confirm detailed job information and change the job name in the window of FIG. 46. To change the job name, the user clicks a key 2089. Then, the window changes to that of FIG. 47, and the user can input a job name similarly to operating the keyboard of a computer.

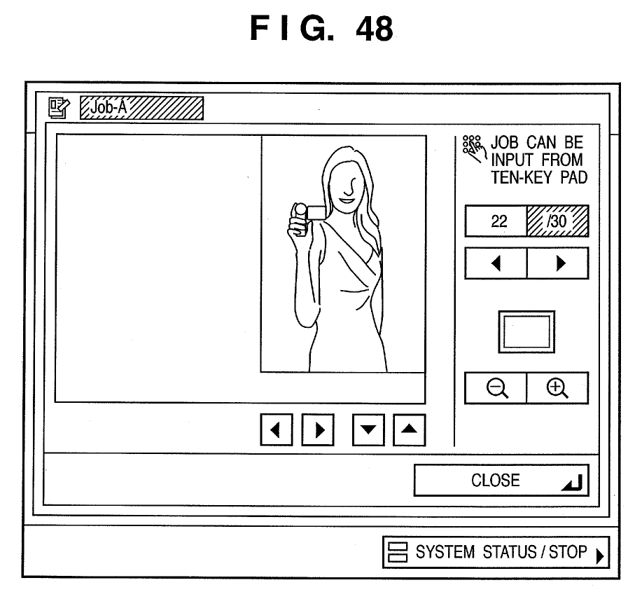

The user clicks the preview key 2045 in the window of FIG. 31, and the window changes to that of FIG. 48 to display the preview image of a selected print job. The user can also select an arbitrary page from a preview window and preview the page.

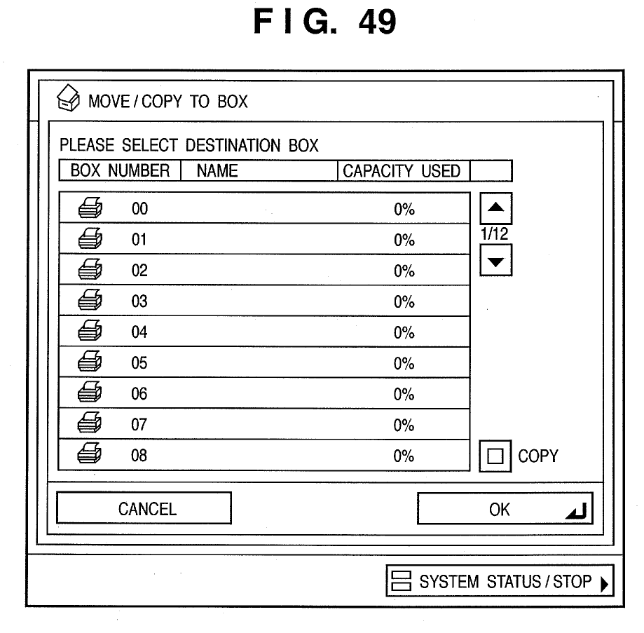

The user clicks the move/copy key 2046 in the window of FIG. 31, and the window changes to that of FIG. 49 to move a print job to another queue (arbitrary box) or copy it.

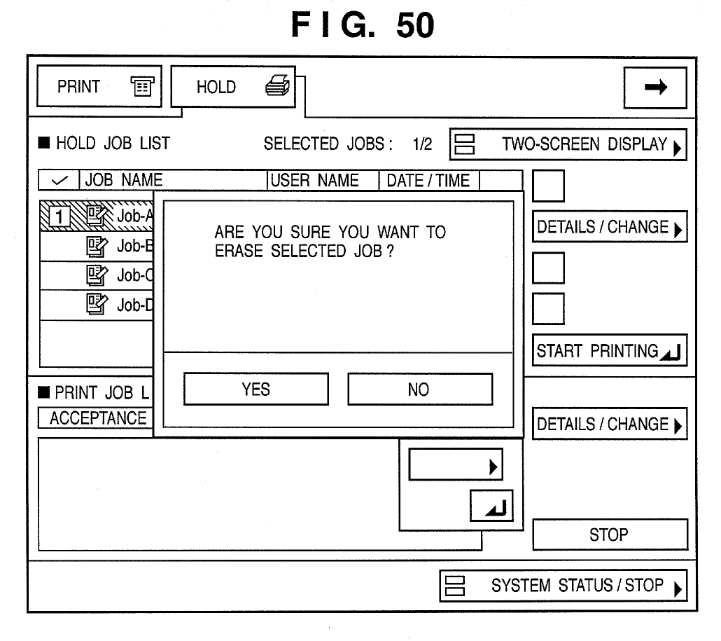

The user clicks the erase key 2047 in the window of FIG. 31 to erase a print job from the hold queue. To erase a print job from the hold queue, a window as shown in FIG. 50 for prompting the user to confirm whether to erase a print job is displayed to prevent an operation error.

### Fourth Embodiment

The first embodiment has described the print process condition change method using the windows of FIGS. 9 to 12. The fourth embodiment will explain another print process condition change method.

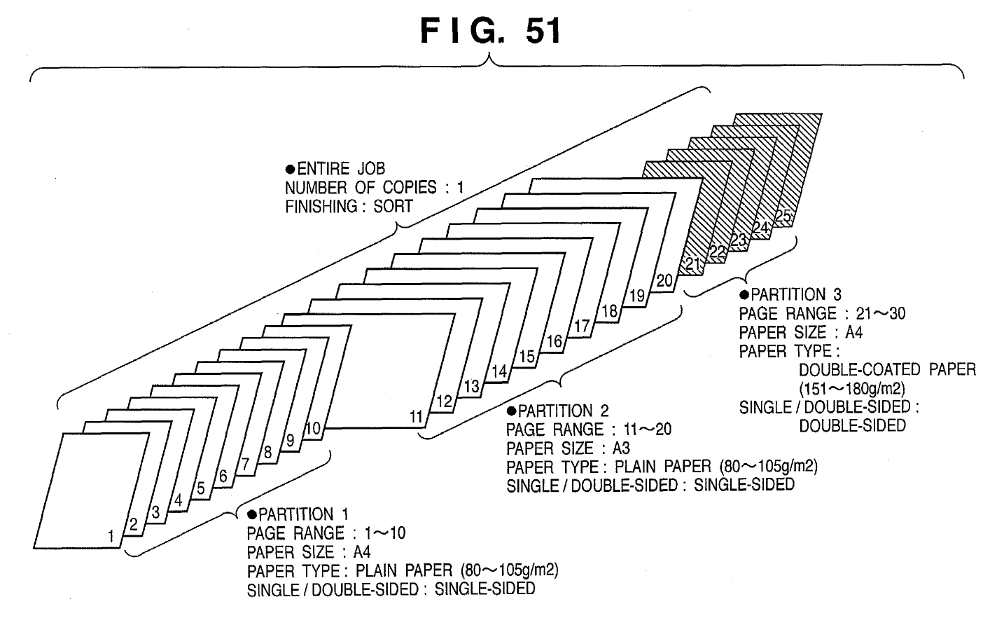

The fourth embodiment assumes that a print job of 30 pages as shown in FIG. 51 is input from a client PC 200 to the hold queue of a document management unit 114. The user of an MFP 100 edits print process condition information of a print job via an operation unit 120, test-prints the print job, and starts printing 50 copies.

The client PC 200 transmits, to the MFP 100, a print job generated using the printer based on an instruction from the user of the client PC. The printer driver running on the client PC 200 generates a print job under print process conditions set by the user via the windows of FIGS. 5 to 7. The fourth embodiment assumes input of a print job to the hold queue of the document management unit 114, so “hold” is designated as an output method 604 in the window of FIG. 6.

The user of the client PC 200 clicks the exceptional setting tab in the window of FIG. 6 to display the window of FIG. 7. The user of the client PC 200 clicks the new creation button in the window of FIG. 7, and a window 702 for setting an exceptional setting application range pops up. The user of the client PC 200 sets “11” as the start page and “20” as the end page in the window 702, defining the 11th to 20th pages as the exceptional setting application range. Further, the user of the client PC 200 sets “designate by a paper type” as the paper designation method 707 in the window of FIG. 7, and sets plain paper (80 to 105 g/m²) as the paper type. The user of the client PC 200 sets “A3” as the paper size and single-sided printing as the printing method, and then clicks the OK button. An exception list 703 displays the exceptional settings of the 11th to 20th pages.

Similarly, the user of the client PC 200 clicks the new creation button again to set the exceptional setting application range of the 21st to 30th pages. In this case, the user of the client PC 200 changes settings to “21 to 30” as the page range, “designate by a paper type” as the paper designation method, double-coated paper (151 to 180 g/m²) as the paper type, “A4” as the output paper size, and double-sided printing as the printing method. After that, the user of the client PC 200 clicks the OK button.

Then, the exception list 703 displays the exceptional settings of the 11th to 20th pages and those of the 21st to 30th pages. The user of the client PC 200 confirms the setting content and clicks the OK button, and after the window returns to that of FIG. 5, again clicks the OK button.

At this time, the printer driver of the client PC 200 generates a print job by adding a job ticket describing print process conditions set via the window of FIG. 5 to PDL data. The client PC 200 transmits the print job to the MFP 100.

The MFP 100 receives the print job and stores it in the hold queue of the document management unit 114 serving as an output-designated destination. After the MFP 100 receives the print job, a hold job list 2021 in FIG. 23 displays the print job. If the transmitted job is Job-A, the hold job list 2021 newly displays Job-A, and the user of the MFP 100 can confirm the job name, user name, and date/time.

If the user of the MFP 100 selects Job-A after completely storing Job-A in the hold queue, a figure appears at a check mark on the left of the job name, and the window of FIG. 24 is displayed. If the user of the MFP 100 clicks a details/change key 2033, the operation unit 120 displays a popup window 2041 of FIG. 31.

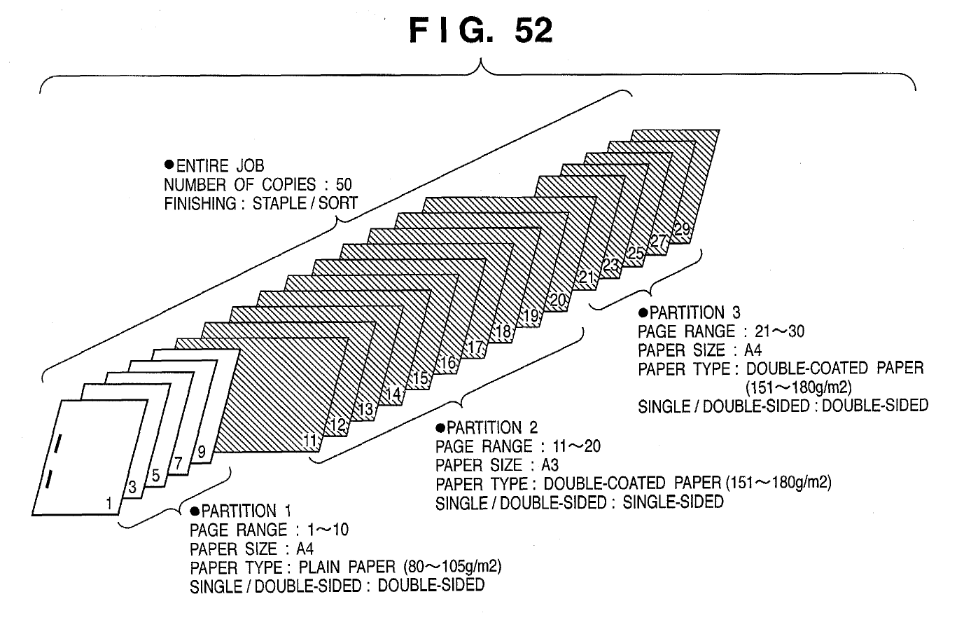

The user of the MFP 100 clicks a job ticket edit key 2042 in the window of FIG. 31, and the window changes to that of FIG. 32. The user of the MFP 100 changes the print process condition setting 2051 of the entire print job. The finishing setting at the print process condition setting 2051 of the entire print job changes from sort to staple/sort, as shown in FIGS. 51 and 52.

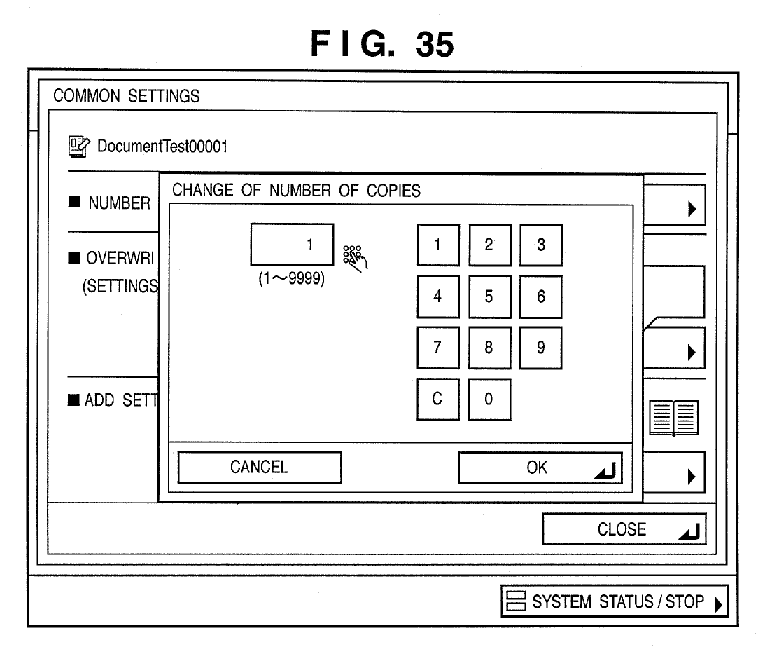

The user of the MFP 100 clicks the edit key 2058 to display the window of FIG. 34. The user of the MFP 100 clicks the copy count change key 2158 via the window of FIG. 34 to display a window as shown in FIG. 35 and set the number of copies. In this case, the user of the MFP 100 changes the number of copies from one to 50. The user of the MFP 100 clicks the finishing key 2059 in the window of FIG. 34, and the operation unit 120 displays the window of FIG. 36. Although sort 2066 is set in advance as the print process condition of the print job received from the client PC 200, the user of the MFP 100 selects a staple/sort key 2068 and clicks the OK key to change the print process condition. At this time, a popup window “settings are saved.” appears, as shown in FIG. 44, and the current setting change is temporarily saved. The window returns to that of FIG. 32, and the print process condition setting 2051 of the entire print job changes from sort to staple/sort.

An example of changing setting 2052 of each page range (partition) will be explained. The user of the MFP 100 selects a page range to be changed from page ranges in FIG. 32. A range of the first to 10th pages will be called a partition 2071, a range of the 11th to 20th pages will be called a page range 2072, and a range of the 21st to 30th pages will be called a page range 2073. The user of the MFP 100 selects the page range 2072. The page range selected by the user of the MFP 100 is checked with a mark. In this state, the user of the MFP 100 clicks the edit key 2074, and the window changes to that of FIG. 38. The user of the MFP 100 clicks the paper selection key 2076 to display the window of FIG. 41. The user of the MFP 100 clicks “designate by a paper type” 2086 to display a paper type list as shown in FIG. 42. The user of the MFP 100 changes the print process condition from plain paper (80 to 105 g/m²) to double-coated paper (151 to 180 g/m²), and clicks the close key. The user of the MFP 100 clicks the OK key 2084 in FIG. 38 to display the window of FIG. 44 including the popup window “settings are saved.” The document management unit 114 saves the setting changes.

At this time, the paper type of the page range 2072 changes from plain paper (80 to 105 g/m²) to double-coated paper (151 to 180 g/m²).

An example when the user of the MFP 100 selects the two partition 2071 and 2073, as shown in FIG. 39, will be explained. The user of the MFP 100 clicks the edit key 2074, and the operation unit 120 displays the window of FIG. 40.

As shown in FIG. 43, the user of the MFP 100 changes the print process condition setting of double-sided printing 2083 from the setting of each page range to the setting of long-edge binding, and clicks the OK key 2084 again. Then, the popup window “settings are saved.” appears, as shown in FIG. 44, and the document management unit 114 saves the current setting change.

Through the above setting change, the print process conditions (FIG. 51) of the print job transmitted from the client PC 200 change to those shown in FIG. 52. The user of the MFP 100 clicks the details/change key 2033 in FIG. 24 again to call the details/change popup window, and clicks the test print key 2043. Then, the window changes to that of FIG. 45. The user of the MFP 100 sets the number of copies and the print range (page range subjected to a print process) as print process conditions of the print job. The user of the MFP 100 clicks the print start key in the window of FIG. 45 to start test printing. If the print result of test printing is proper, actual printing starts. The print process starts by clicking the print start key 2036 in the window of FIG. 24. Since the number of copies by the print job shown in FIG. 52 changes to 50 by the common setting of the print job, 50 copies of a 30-page printed material are successively printed.

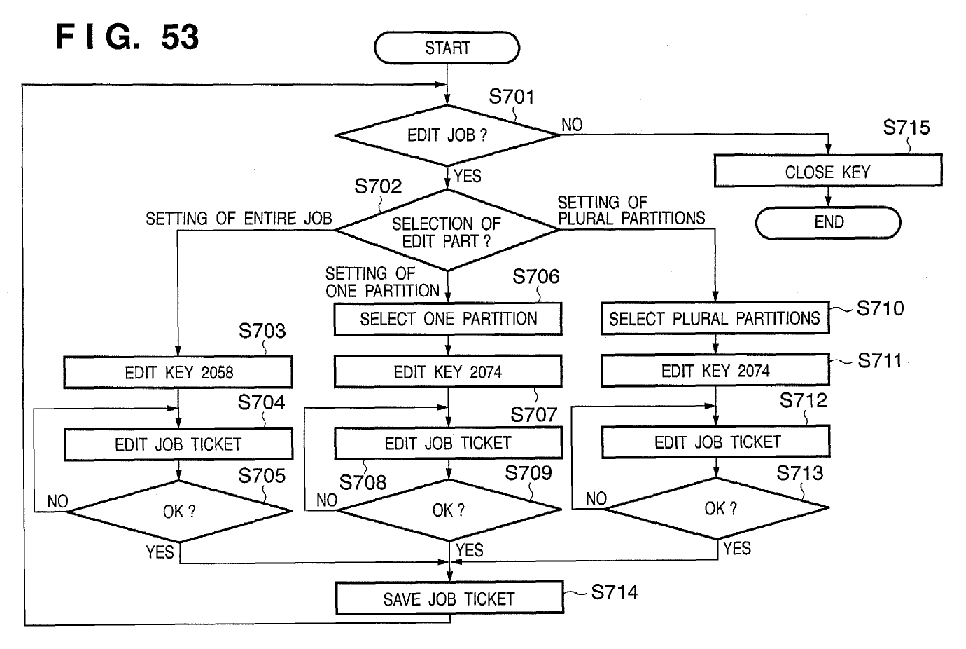

The above-described operation executed by the MFP control unit 108 will be explained with reference to the flowchart of FIG. 53. The MFP control unit 108 displays a hold job list, similar to step S401 of FIG. 17 in the first embodiment, and a user selects a print job, similar to step S402 of FIG. 17. In this state, the MFP control unit 108 starts the operation in FIG. 53. In step S701, the MFP control unit 108 determines whether the user has clicked the job ticket edit key 2042 via the window of FIG. 31. If the user has clicked the job ticket edit key 2042 (YES), the process advances to step S702; if NO, to step S715.

In step S702, the MFP control unit 108 determines which job ticket of the print job is selected by the user for editing. As already described above, there are three job ticket editing methods, and the user selects one of them:
(first editing method) setting of print process conditions for an entire print job;
(second editing method) setting of print process conditions for one partition selected by the user; and
(third editing method) setting of print process conditions for a plurality of partitions selected by the user.

If the user selects the first editing method, the process advances from S702 to S703. The user clicks the edit key 2058 (S703), sets print process conditions for the entire print job via the window of FIG. 34 (S704), and clicks the OK key (S705).

If the user selects the second editing method, the process advances from S702 to S706. The user selects one desired partition from the setting 2052 of each page range (S706), clicks the edit key 2074 (S707), sets print process conditions for each page via the window of FIG. 38 (S708), and clicks the OK key (S709).

If the user selects the third editing method, the process advances from S702 to S710. The user selects a plurality of desired partitions from the setting 2052 of each page range (S710), clicks the edit key 2074 (S711), sets print process conditions for each page via the window of FIG. 40 (S712), and clicks the OK key (S713).

Regardless of the editing method, the document management unit 114 saves, by overwrite, print process condition information (job ticket information) saved in the hold queue after clicking the OK key (3714). If the document management unit 114 has sufficient memory capacity, it may save a new job ticket information while saving the old one.

The MFP control unit 108 repeats the operation of steps S701 to S714, and after editing the job ticket (NO in step S701), ends editing of the job ticket (S715).

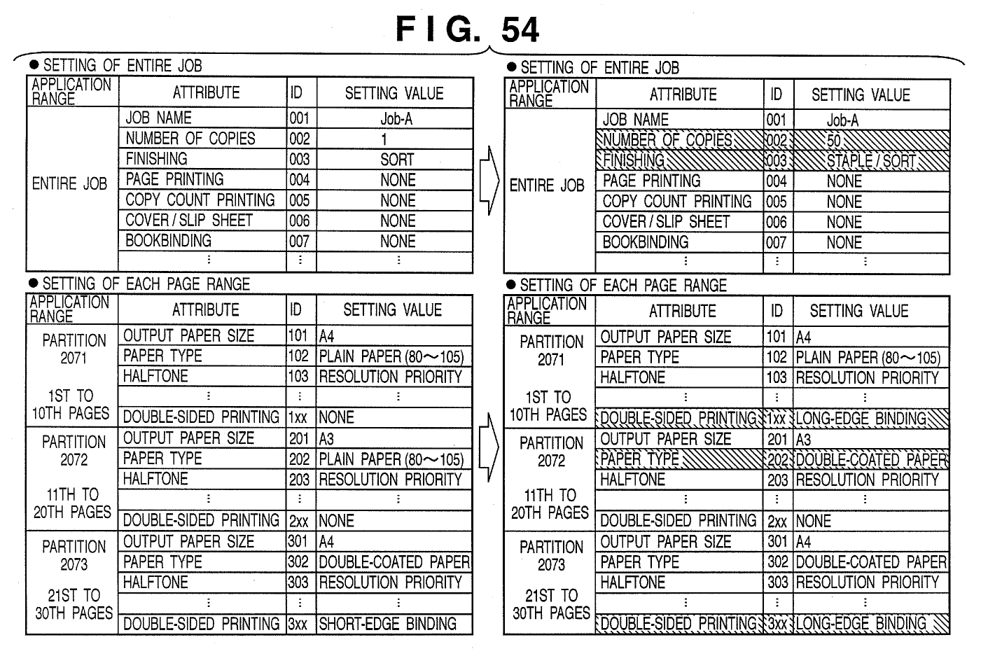

FIG. 54 shows an example of the print process condition information (job ticket information) held by the document management unit 114 before and after the MFP control unit 108 executes the operation in FIG. 53. In the print process condition settings of the entire print job, the number of copies changes from one to 50, and finishing changes from sort to staple/sort. In the settings of each page range, the print process condition of the partition 2071 changes from “no double-sided printing” to “long-edge binding”. The paper type of the partition 2072 changes from plain paper (80 to 105 g/m²) to double-coated paper (151 to 180 g/m²). Further, the print process condition of the partition 2073 changes from “double-sided printing with short-edge binding” to “double-sided printing with long-edge binding”.

Print process conditions settable by the three job ticket editing methods will be described.

There are various print process conditions, and it is not always preferable to set the same print process conditions by the three job ticket editing methods.

For example, only one job name should be given to a print job, and no job name need be set for each partition. The bookbinding setting such as saddle stitching or case binding must be set as a print process condition of the entire print job. It is desirable to set the number of copies as a print process condition not of each partition but the entire print job. Changes in print process conditions such as the paper size and type must be permitted between respective pages.

Some print process conditions are desirably set at once for a plurality of partitions. For example, the print process condition of the partition 2071 is “no double-sided printing”, and that of the partition 2073 is “double-sided printing with short-edge binding”. In this case, it is desirable to set the print process conditions of the partitions 2071 and 2073 at once.

Particularly in the POD market, a print job has many pages, and a plurality of partitions are often set in the print job.

As described above, some print process conditions are desirably set by each of the three job ticket editing methods, and some are not. The types of print process conditions are classified as follows:
(first print process condition) a print process condition settable by the first editing method;
(second print process condition) a print process condition settable by the second editing method; and
(third print process condition) a print process condition settable by the third editing method.

Print process conditions set in FIGS. 34 and 36 correspond to the first print process condition. More specifically, the first print process condition includes the number of copies, designation of the delivery destination, designation of finishing (sorting, grouping, or stapling) by a finisher, whether to perform page printing, whether to perform copy count printing, and setting of a cover/slip sheet.

Print process conditions set in FIGS. 38 and 40 correspond to the second and third print process conditions. More specifically, the second and third print process conditions include the paper size, adjustment of the toner density, gradation/smoothing, binding margin, movement of the print area, whether to perform double-sided printing, designation of finishing by a finisher, and designation of the delivery destination.

A print process condition settable by any of the first, second, and third print process conditions is designation of finishing (sorting, grouping, or stapling) by a finisher. When finishing is designated for an entire print job, no finishing need be designated for each partition. Thus, when finishing is designated for the entire print job, the windows in FIGS. 38 and 40 invalidate the delivery method (finishing designation).

Although not shown in the examples of FIGS. 38 and 40, page printing may be a print process condition corresponding to all of the first, second, and third print process conditions. For example, it is set to print the page number of the entire print job and the page number of a partition, and shift the print positions of the respective page numbers.

A job ticket contained in a print job transmitted by the client PC 200 may describe which of the first, second, and third print process conditions corresponds to a given print process condition. This setting can prevent change of a print process condition which should not be changed in the print job.

The JDF (Job Definition Format) can also describe a job ticket containing the above-described print process conditions. The JDF can describe a job ticket associated with a whole print process, and a job ticket associated with each partition.

### Other Embodiment

In the above embodiments, when change of print process conditions for each page group is inhibited in a print job received by the printing apparatus, display of the application range list (list table) on the window may be inhibited.

When the print process conditions of a print job are set separately for respective page groups, they are displayed in application range lists divided for the respective page groups. To the contrary, when one print process condition is set for the entire print job, only one print process condition is displayed. Alternatively, when one print process condition is set for the entire print job, a setup window for changing the print process condition may be displayed.

It is also possible to select a plurality of page groups and change their print process conditions at once when the range in which the print process condition settings of a print job are changed is selected for each page group. Selection of page groups, and change of their print process conditions may be based on instructions from an external device connected to the printing apparatus via a network.

The embodiments have been described in detail. The present invention can take the form of a system, apparatus, method, program, storage medium (recording medium), or the like. More specifically, the present invention may be applied to a system including a plurality of devices or an apparatus formed by a single device.

The present invention is also achieved as follows. That is, a software program (in the above embodiments, a program corresponding to the flowcharts shown in the drawings) for implementing the functions of the above-described embodiments is supplied to a system or apparatus directly or from a remote place. The computer of the system or apparatus reads out and executes-the supplied program codes.

The present invention is therefore implemented by program codes installed in the computer in order to implement functional processes of the present invention by the computer. That is, the present invention includes a computer program for implementing functional processes of the present invention.

In this case, the present invention can be implemented as a program such as an object code, a program executed by an interpreter, or script data supplied to an OS as long as a program function is attained.

A recording medium for supplying the program includes a floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can be downloaded and supplied from an Internet homepage to a recording medium such as a hard disk by using the browser of a client computer. That is, the client computer connects to the homepage and downloads the computer program of the present invention or a compressed file containing an automatic installing function. The program can also be implemented by grouping program codes which form the program of the present invention into a plurality of files, and downloading the files from different homepages. That is, the present invention also incorporates a WWW server which allows a plurality of users to download the program files for implementing functional processes of the present invention by a computer.

The program of the present invention can be encrypted, stored in a storage medium such as a CD-ROM, and distributed to a user. A user who satisfies predetermined conditions is prompted to download decryption key information from a homepage via the Internet. The user executes the encrypted program using the key information, and installs the program in the computer.

The functions of the above-described embodiments are implemented when the computer executes the readout program. Also, the functions of the above-described embodiments are implemented when an OS or the like running on the computer performs some or all of actual processes based on the instructions of the program.

The functions of the above-described embodiments are implemented when the program read out from the recording medium is written in the memory of a function expansion board inserted into the computer or the memory of a function expansion unit connected to the computer. That is, the CPU of the function expansion board or function expansion unit performs some or all of actual processes based on the instructions of the program codes.

The present invention can partially change the print process conditions of a print job containing image data of pages, and improve user friendliness. Especially in work to adjust an image while outputting it, a user need not transfer print data again from a host apparatus, improving user friendliness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-006446, filed Jan. 13, 2006, 2007-002879, filed Jan. 10, 2007, which are hereby incorporated by reference herein in their entirety.

What is claimed is:

1. A printing system including an information processing apparatus and a printing apparatus,
said information processing apparatus comprising:
a setting unit adapted to set, for each page range, a print process condition used to print image data of a plurality of pages;
a generation unit adapted to generate a print job including the print process condition set by said setting unit and the image data; and
a transmission unit adapted to transmit the print job generated by said generation unit to said printing apparatus, and
said printing apparatus comprising:
a reception unit adapted to receive the print job transmitted by said transmission unit;
a change unit adapted to change, for each page range, the print process condition included in the print job received by said reception unit; and
a printing unit adapted to execute the print job based on the print process condition changed by said change unit.

2. The printing system according to claim 1, wherein when different print process conditions are set for respective page ranges as the print process condition of the print job, said change unit changes print process conditions of the respective page ranges having the different print process conditions to a specific print process condition at once.

3. The printing system according to claim 1, wherein
said printing apparatus further comprises a display unit adapted to display the print job identifiably for each page range, and
when one of page ranges displayed by said display unit is selected, said change unit changes a print condition of the selected page range.

4. The printing system according to claim 1, wherein said change unit can change a start page and end page of the page range.

5. The printing system according to claim 1, wherein
said generation unit can add, to the print job, information representing whether to start the print process based on the print job in accordance with an instruction from a user of said printing apparatus, and
when information representing to start the print process in accordance with an instruction from the user is added to the print job, said printing unit starts the print process based on the print job in accordance with an instruction to start the print process from the user.

6. The printing system according to claim 1, wherein said change unit can change the print process condition contained in the print job received by said reception unit, for each page based on an instruction from an external device.

7. The printing system according to claim 1, wherein said change unit can change the print process condition so as to set the single print process condition for all pages of the print job at once, and
wherein the print process conditions, which can be set by the setting unit, include a print process condition which cannot be changed for all pages at once but can be changed for each page.

8. The printing system according to claim.1, wherein said change unit can change the print process condition so as to set the single print process condition for all pages of the print job at once, and
wherein the print process conditions, which can be set by the setting unit, include a print process condition which cannot be changed for each page but can be changed for all page at once.

9. A printing apparatus communicating with an information processing apparatus having a setting unit adapted to set, for each page range, a print process condition used to print image data of a plurality of pages, a generation unit adapted to generate a print job including the print process condition set by the setting unit and the image data, and a transmission unit adapted to transmit the print job generated by the generation unit to said printing apparatus, said printing apparatus comprising:
a reception unit adapted to receive the print job transmitted by the transmission unit;
a change unit adapted to change, for each page range, the print process condition contained in the print job received by said reception unit; and
a printing unit adapted to execute a print process based on the print process condition changed by said change unit.

10. The printing apparatus according to claim 9, wherein when different print process conditions are set for respective page ranges as the print process condition of the print job, said change unit changes print process conditions of the respective page ranges having the different print process conditions to a specific print process condition at once.

11. The printing apparatus according to claim 9, wherein
said printing apparatus further comprises a display unit adapted to display the print job identifiably for each page range, and
when one of page ranges displayed by said display unit is selected, said change unit changes a print condition of the selected page range.

12. The printing apparatus according to claim 9, wherein said change unit can change a start page and end page of the page range.

13. The printing apparatus according to claim 9, wherein
the generation unit can add, to the print job, information representing whether to start the print process based on the print job in accordance with an instruction from a user of said printing apparatus, and
when information representing to start the print process in accordance with an instruction from the user is added to the print job, said printing unit starts the print process based on the print job in accordance with an instruction to start the print process from the user.

14. The printing apparatus according to claim 9, wherein said change unit can change the print process condition contained in the print job received by said reception unit, for each page range based on an instruction from an external device.

15. The printing apparatus according to claim 9, wherein said change unit can change the print process condition so as to set the single print process condition for all pages of the print job at once, and
wherein the print process conditions, which can be set by the setting unit, include a print process condition which cannot be changed for all pages at once but can be changed for each page.

16. The printing apparatus according to claim 9, wherein said change unit can change the print process condition so as to set the single print process condition for all pages of the print job at once, and
wherein the print process conditions, which can be set by the setting unit, include a print process condition which cannot be changed for each page but can be changed for all page at once.

17. A method for printing, comprising the steps of:
causing an information processing apparatus to set, for each page range, a print process condition used to print image data of a plurality of pages;
causing the information processing apparatus to generate a print job by adding the print process condition set to the image data of the plurality of pages;
transmitting the generated print job from the information processing apparatus to a printing apparatus;
causing the printing apparatus to receive the transmitted print job;
causing the printing apparatus to change, for each page range, the print process condition contained in the received print job; and
causing the printing apparatus to execute a print process on the basis of the changed print process condition.
